(19) United States
(12) Patent Application Publication
(10) Pub. No.: US 2026/0328564 A1
(43) Pub. Date: Oct. 22, 2026

(54) FOAM LAYER MEASURING SYSTEM

(71) Applicant: Life Technologies Corporation, Carlsbad, CA (US)

(72) Inventors: Mark Thomas Smith, Nibley, UT (US); Joshua Lynn Adams, Smithfield, UT (US); Ronald Abraham Martin, Smithfield, UT (US)

(21) Appl. No.: 19/105,952

(22) PCT Filed: Aug. 23, 2023
(86) PCT No.: PCT/US2023/072755

§ 371 Date: Feb. 24, 2025

Related U.S. Application Data
(60) Provisional application No. 63/400,697, filed on Aug. 24, 2022.

(51) Int. Cl. G01B 15/02; B01D 19/00; B01D 19/04; G01F 22/02; G01F 23/284; G01S 13/08

(52) U.S. Cl. CPC G01B 15/02; B01D 19/0063; B01D 19/04; G01F 22/02; G01F 23/284; G01S 13/08

(57) ABSTRACT

Systems and methods for measuring a foam layer in a fluid processing system are disclosed. The system includes a container having a chamber for containing a liquid and the foam layer. The system includes a first sensor positioned adjacent a top portion of the chamber. The first sensor is configured to measure a first distance between a top foam surface of the foam layer and the first sensor. The system includes a second sensor coupled to the container, the second sensor configured to measure a mass of the liquid. The system also includes a processor configured to perform the operations of calculating a thickness of the foam layer based on dimensions of the chamber of the container, the measured first distance between the top foam surface of the foam layer and the first sensor, and the mass of the liquid as measured by the second sensor.

### CROSS-REFERENCE TO RELATED APPLICATIONS

This application claims the benefit of U.S. Provisional Application No. 63/400,697, filed on Aug. 24, 2022, which is incorporated herein by specific reference.

### BACKGROUND

The biopharmaceutical industry uses a broad range of mixing systems for a variety of processes such as in the preparation of media and buffers and in the growing, mixing and suspension of cells and microorganisms. Some conventional mixing systems, including bioproduction equipment (e.g., bioreactors and fermenters), comprise a flexible bag disposed within a rigid support housing. An impeller can be disposed within the flexible bag and coupled with a drive shaft projecting into the bag. Rotation of the drive shaft and impeller facilitates mixing and/or suspension of a liquid contained within the flexible bag.

For example, the growing, mixing, and suspension of cells and microorganisms in a liquid contained in the flexible bag can generate a foam layer within the flexible bag above the liquid. Excessive foam inside the flexible bag and bioreactor can clog filters associated with the mixing system, interfere with oxygen transfer at the liquid surface, result in unwanted buildup of gas (e.g., ammonia, carbon dioxide), and/or cause the flexible bag to rupture and compromise a sanitary seal. For example, filters becoming clogged due to foam can be problematic as clearing the filters can interfere with processing the liquid. Additionally, compromising the sanitary seal can contaminate the liquid and result in disposal of the liquid. As such, excessive foam can disrupt the growing, mixing, and suspension of cells and microorganisms.

Currently, the amount of foam and/or the thickness of the foam layer can be controlled using anti-foam solutions. Such anti-foam solutions present their own set of challenges, including reducing oxygen transfer and complicating downstream purification of the liquid. For example, if anti-foam solution is added to the liquid, the anti-foam solution must be removed from the final product. This anti-foam purification process can be detrimental to the quality of the final product and present extra processing steps. For example, anti-foam solution can be detrimental to the growing, mixing, and suspension of cells and microorganisms. As such, the amount of anti-foam solution applied to the foam and liquid should be minimized. Accordingly, there are several technical and logistical challenges associated with foam formation in bioproduction equipment, as well as in other liquid mixing systems.

### SUMMARY OF THE DISCLOSURE

It is understood that each independent aspect recited herein may include any of the features, options, and possibilities recited in association with the other independent aspects set forth above or as recited elsewhere within this document.

Example foam layer measuring systems and devices and methods of use thereof are herein disclosed. An example system for determining a measurement of a foam layer in a fluid processing system can comprise: a container having a chamber for containing a liquid and the foam layer, the foam layer present above the liquid; a first sensor positioned adjacent a top portion of the container, the first sensor configured to measure a foam distance between a top foam surface of the foam layer and the first sensor; a second sensor positioned adjacent to the container, the second sensor configured to receive a measurement to determine a top liquid surface height of the liquid; and a controller communicatively coupled to the first sensor and the second sensor, the controller configured to perform operations comprising: calculating a thickness of the foam layer based on a difference between the measured foam distance and the measurement received from the second sensor. The operations can further comprise: determining whether the calculated thickness of the foam layer satisfies a foam layer threshold, the foam layer threshold defining when the foam layer is to be reduced; and performing, in response to satisfying the foam layer threshold, an action to reduce the foam layer. The action can comprise adding a volume of an anti-foam solution to the chamber. The action can comprise activating or adjusting a component of the fluid processing system. The volume of the anti-foam solution added to the chamber can be based on at least one of a proportional-integral-derivative (PID) control algorithm or a model predictive control algorithm. The volume of the anti-foam solution added to the chamber can be determined based on the calculated thickness or a calculated volume of the foam layer. The first sensor and the second sensor can be the same sensor. The first sensor and the second sensor can be radar sensors. The determining the calculated thickness of the foam layer further can comprise performing the operations of: obtaining, from the first sensor, a reference distance between a base of the chamber and the first sensor; obtaining, from the first sensor, the foam distance between the top foam surface of the foam layer and the first sensor; and calculating a first distance based on a difference between the foam distance and the reference distance. The determining the calculated thickness of the foam layer further can comprise performing the operations of: determining the top liquid surface height of the liquid; and calculating the thickness of the foam layer by determining a difference between the first distance and the top liquid surface height of the liquid. The determining the top liquid surface height of the liquid can comprise calculating a volume of the liquid. The volume of the liquid can be calculated using a measured mass of the liquid taken by the second sensor and a density of the liquid. The top liquid surface height of the liquid can be determined using a measured pressure of the liquid taken by the second sensor. A gas holdup volume in the volume of the liquid can be determined for determining the thickness of the foam layer. The volume of the liquid can be calculated using at least one dimension of the chamber. The chamber can be positioned within the container and the first sensor is positioned outside the container. The first sensor can be a radar sensor. In some embodiments, at least a part of the top portion of the container can be formed of a material that is radar transparent. The container can comprise a bag. The first sensor can be a LiDAR sensor. The second sensor can be a load sensor. The second sensor can be a pressure sensor. In some embodiments, a rate at which the first sensor obtains measurements can be continuous. In some embodiments, at least one of the first sensor and the second sensor can be coupled to the container.

In various embodiments, a method for determining a measurement of a foam layer in a container of a fluid processing system can comprise: measuring, with a first sensor, a distance between the first sensor and a top surface of the foam layer on top of a liquid in the container; measuring, with a second sensor, a mass of the liquid or a pressure exerted by a column height of the liquid in the container; and calculating, using one or more processors, a thickness of the foam layer based on the distance between the first sensor and the top surface of the foam layer and at least one of the mass of the liquid and the pressure exerted by a column height of the liquid. In some embodiments, the method can further comprise: determining, using the one or more processors, whether the calculated thickness of the foam layer satisfies a first foam layer threshold, the first foam layer threshold defining when the foam layer is to be reduced; and controlling an action, using a controller, to reduce a presence and/or formation of the foam layer in response to satisfying the first foam layer threshold. In some embodiments, the method can further comprise: determining, using the one or more processors, whether the calculated thickness of the foam layer satisfies a second foam layer threshold, the second foam layer threshold defining when the foam layer is to be reduced; and controlling the action, using the controller, to reduce a presence and/or formation of the foam layer in response to satisfying the second foam layer threshold. The action can comprise adding a volume of an anti-foam solution to the container. The action can comprise activating or adjusting one or more components of the fluid processing system. The volume of the anti-foam solution added to the chamber can be based on at least one of a proportional-integral-derivative (PID) control algorithm or a model predictive control algorithm. The volume of the anti-foam solution added to the chamber can be determined based on the calculated thickness or a calculated volume of the foam layer. The first sensor and the second sensor can be the same. The first sensor and the second sensor can be radar sensors.

In various embodiments, a non-transitory computer-readable storage medium can be used for determining a measurement of a foam layer in a container of a fluid processing system, the non-transitory computer-readable storage medium comprising at least one program for execution by one or more processors of a first device, the at least one program including instructions which, when executed by the one or more processors, cause the first device to perform operations comprising: receiving, at the first device from a first sensor, a measured distance between the first sensor and a top surface of the foam layer on top of a liquid in the container; receiving, at the first device from a second sensor, a measured mass of the liquid or a pressure exerted by a column height of the liquid in the container; and calculating, using the one or more processors, a thickness of the foam layer based on the distance between the first sensor and the top surface of the foam layer and at least one of the mass of the liquid and the pressure exerted by a column height of the liquid.

In various embodiments, a system for determining a measurement of a foam layer in a fluid processing system, the system can comprise: a container having a chamber for containing a liquid and the foam layer, the foam layer present above the liquid; a radar sensor positioned adjacent a top portion of the chamber, the radar sensor configured to measure a foam distance between a top foam surface of the foam layer and the radar sensor; a controller communicatively coupled to the radar sensor, the controller configured to perform operations comprising: calculating a thickness of the foam layer based on the measured foam distance and a top liquid surface height of the liquid.

In various embodiments, a method for determining a measurement of a foam layer in a container of a fluid processing system can comprise: measuring, with a radar sensor, a distance between the radar sensor and a top surface of the foam layer; calculating, using one or more processors, a thickness of the foam layer based on the distance between the radar sensor and the top surface of the foam layer.

In various embodiments, a system for suppressing foam in a fluid processing system can comprise: a container having a top-wall, sidewalls and a bottom-wall that form a chamber for containing a fluid that generates a foam layer; a radar sensor positioned outside of the container and adjacent to the top-wall and configured to emit an electromagnetic wave or radio wave used to measure a height of the foam layer within the container; and a first mass sensor positioned outside of the container and configured to measure a mass of the fluid within the container. In some embodiments, the system can further comprise a second mass sensor. The fluid can be a biological fluid. The biological fluid can be a cell culture. The container can comprise a flexible bag. The first and second mass sensors can be hydrodynamic pressure sensors. In some embodiments, the system can further comprise a controller configured to determine a foam layer thickness based on the height of the foam layer, the measured mass of the fluid, and/or a volume of the fluid. In some embodiments, the system can further comprise an anti-foam dispenser in communication with the controller further configured to cause the anti-foam dispenser to dispense a volume of anti-foam solution into the container. In some embodiments, the system can further comprise a mixer at least partially within the container. In some embodiments, the system can further comprise a sparger coupled to the container. In some embodiments, the system can further comprise a third sensor, the third sensor positioned in or adjacent to a gas flow pathway of the sparger and configured to measure gas flow rate in the gas flow pathway.

In various embodiments, a system for determining a measurement of a foam layer in a fluid processing system can comprise: a container having a chamber for containing a liquid and the foam layer, the foam layer present above the liquid; a first sensor positioned adjacent a top portion of the container, the first sensor configured to measure one or more of a foam distance and a liquid distance, the foam distance extending between a top foam surface of the foam layer and the first sensor, the liquid distance extending between a top liquid surface of the liquid and the first sensor; a second sensor comprising an optical device positioned to collect image data of one or more of the top liquid surface and the foam layer; and a controller communicatively coupled to the first sensor and the second sensor, the controller configured to perform operations comprising: determining, based on collected image data, an amount of foam layer coverage along the top liquid surface; and calculating a thickness of the foam layer based on a difference between the measured foam distance and the measured liquid distance. The first sensor can comprise a radar. In some embodiments, the system can further comprise a third sensor configured to measure the liquid distance, and wherein the first sensor is configured to measure the foam distance. The optical device can comprise one or more of a camera, a video recording device, and a LiDAR. The amount of foam layer coverage can comprise a percentage of the top liquid layer that is covered by the foam layer. The controller can be further configured to calculate a volume of the foam layer based on a determined amount of foam layer coverage and the calculated thickness of the foam layer. The controller can be further configured to control, based on the calculated thickness of the foam layer or volume of the foam layer, a delivery of anti-foam to the chamber to reduce a volume of the foam layer.

In various embodiments, a system for determining a measurement of a foam layer in a fluid processing system can comprise: a container having a chamber for containing a liquid and the foam layer, the foam layer present above the liquid; a first sensor positioned adjacent a top portion of the container, the first sensor configured to measure a foam distance extending between a top foam surface of the foam layer and the first sensor; a second sensor comprising an optical device positioned to collect image data of the liquid and/or the foam layer; a third sensor configured to measure a liquid mass measurement of the liquid; and a controller communicatively coupled to the first sensor, the second sensor, and the third sensor, the controller configured to perform operations comprising: determining, based on collected image data, an amount of foam layer coverage along a top liquid surface; and calculating a thickness of the foam layer based on the measured foam distance and the measured liquid mass. The first sensor can comprise a radar. The optical device can comprise one or more of a camera, a video recording device, and a LiDAR. The amount of foam layer coverage can comprise a percentage of the top liquid surface that is covered by the foam layer. The controller can be further configured to calculate a volume of the foam layer based on a determined amount of foam layer coverage and the calculated thickness of the foam layer. The controller can be further configured to control, based on the calculated thickness of a foam layer or volume of the foam layer, a delivery of anti-foam to the chamber to reduce the volume of the foam layer. The controller can be further configured to control, based on the calculated thickness of the foam layer or volume of the foam layer, one or more components of the fluid processing system to reduce the volume of the foam layer.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 illustrates a perspective view of a fluid processing system according to exemplary embodiments of the present disclosure;

FIG. 2 illustrates a perspective view of a container and drive motor assembly of the fluid processing system according to exemplary embodiments of the present disclosure;

FIG. 3 illustrates a foam layer measuring hardware including a controller, a first sensor, and a second sensor according to exemplary embodiments of the present disclosure;

FIG. 4 illustrates an implementation of the foam layer measuring hardware of FIG. 3 at a container according to exemplary embodiments of the present disclosure;

FIGS. 5A-5B illustrate different views of a radar sensor and mounting bracket according to exemplary embodiments of the present disclosure;

FIG. 6 illustrates a foam layer thickness graph showing a correlation between agitating and sparging process fluid and a thickness of the foam layer according to exemplary embodiments of the present disclosure;

FIG. 7A illustrates a timed dosing control graph showing timed dosing control method for maintaining a thickness of the foam layer according to exemplary embodiments of the present disclosure;

FIG. 7B illustrates a first height threshold dosing control graph showing height threshold dosing control method for maintaining a thickness of the foam layer according to exemplary embodiments of the present disclosure;

FIG. 7C illustrates a second height threshold dosing control graph showing height threshold dosing control method for maintaining a thickness of the foam layer according to exemplary embodiments of the present disclosure;

FIG. 8A illustrates a PID control graph showing proportional-integral-derivative (PID) control for maintaining a thickness of the foam layer according to exemplary embodiments of the present disclosure;

FIG. 8B illustrates a model predictive control graph showing model predictive control for maintaining a thickness of the foam layer according to exemplary embodiments of the present disclosure;

FIG. 9 illustrates anti-foam consumption graph based on anti-foam application controls according to exemplary embodiments of the present disclosure;

FIG. 10 illustrates a foam layer measuring process according to exemplary embodiments of the present disclosure;

FIG. 11 illustrates a block diagram depicting an example of a computing system consistent with implementations of the current subject matter;

FIG. 12 illustrates a diagram of foam layer measurement system integrated with a bioreactor controller, consistent with implementations of the current subject matter;

FIG. 13 illustrates a diagram of a foam layer measurement system integrated with a bioreactor controller and a standalone processing unit, consistent with implementations of the current subject matter;

FIG. 14 illustrates a diagram of a foam layer measurement system integrated with a standalone processing unit, consistent with implementations of the current subject matter;

FIGS. 15A-15C show data obtained from live cell culture in a bioreactor system comprising a foam layer measurement system, consistent with implementations of the current subject matter;

FIGS. 16A-16C show data obtained from live cell culture in a bioreactor system comprising a foam layer measurement system, consistent with implementations of the current subject matter;

FIGS. 17A-17C show data obtained from live cell culture in a bioreactor system comprising a foam layer measurement system, consistent with implementations of the current subject matter;

FIGS. 18A-18B show experimental data obtained from a bioreactor system comprising a foam layer measurement system with a first foam threshold setpoint value, consistent with implementations of the current subject matter;

FIGS. 19A-19B show experimental data obtained from a bioreactor system comprising a foam layer measurement system with a second foam threshold setpoint value compared to the first foam threshold value shown in embodiments illustrated in FIGS. 18A-18B, consistent with implementations of the current subject matter;

FIGS. 20A-20C show data obtained from live cell culture in a bioreactor system comprising a foam layer measurement system, consistent with implementations of the current subject matter;

FIG. 21 shows data obtained from live cell culture in a bioreactor system operated with manual control of foam level (lower panel; foam height (B)) and data obtained from live cell culture under the same conditions in a bioreactor system operated with a foam level management system described herein (upper panel; foam height (A)), consistent with implementations of the current subject; and

FIG. 22 shows a staged foam response protocol in a bioreactor system comprising a foam layer measurement system with a first foam threshold setpoint value, consistent with implementations of the current subject matter.

The figures may not be to scale in absolute or comparative terms and are intended to be exemplary. The relative placement of features and elements may have been modified for the purpose of illustrative clarity. Where practical, the same or similar reference numbers denote the same or similar or equivalent structures, features, aspects, or elements, in accordance with one or more embodiments.

### DETAILED DESCRIPTION

The present disclosure provides systems and methods for efficiently and effectively measuring and controlling (e.g., reducing, suppressing) a foam layer in a container of a fluid processing system, such as in a single-use flexible bag and/or bioproduction equipment (e.g., mixer, bioreactor, fermenter, etc.). For example, fluid processing systems can be configured for biological reactions, including but not limited to, growing cells or other biological components. In example embodiments, fluid processing system can also comprise or be substituted with one or more bioreactors, fermenters, mixers, storage vessels, fluid management systems, cell culture equipment, centrifuges, centrifugal separators, chromatography units, mixers, homogenizers, magnetic processing units, blood separating devices, biocomponent filtering devices, biocomponent agitators or any other device designed for growing, mixing or processing cells and/or other biological components. It is also appreciated that fluid processing system can comprise any conventional type of bioreactor, fermenter, or cell culture devices such as a stirred-tank reactor, rocker-type reactor, paddle mixer reactor, or the like.

For example, various embodiments of a foam layer measuring system are described that are configured to measure the foam layer and help control and reduce a thickness and/or volume of the foam layer formed above a liquid in a processing chamber (e.g., mixing or reaction chamber). Foam formation is common during normal operation of bioproduction equipment and can be detrimental to the function of the bioproduction equipment. In some cases, foam can be formed by air in the liquid of bioproduction equipment, which may be introduced by sparging or mechanical agitation of the liquid. Proteins, lipids, and/or carbohydrates in the liquid can stabilize foam once it is formed, which can rapidly result in problematic accumulation of foam in the system. Once established, significant accumulations of foam in a bioproduction system can be difficult to remedy, often requiring implementation of additional or different foam-abatement efforts. Reducing the thickness and/or volume of the foam layer can prevent clogging of filters associated with the bioproduction equipment, contamination of the liquid due to broken seals, ammonia/carbon dioxide buildup within the foam layer, and interference with the oxygen transfer at the surface of the liquid. For example, the liquid can be a medium for culturing bacteria, fungi, algae, plant cells, animal cells, protozoans, nematodes, white blood cells, T-cells, cell media, plasmids, viral vectors, blood, plasma, organelles, proteins, nucleic acids, lipids, plasmids, carbohydrates, and/or other biological components, and the like. Examples of some common biological components include E. coli, yeast, bacillus, and CHO cells, cell-therapy cultures and cells, and microorganisms that are aerobic or anaerobic and adherent or non-adherent and the like. The liquid can also be used for chemicals, food products, beverages, and other liquid products. Additionally, the foam layer measuring system can minimize or eliminate an amount of foam formation and/or presence of foam within a container, thereby reducing time and cost associated with bioproduction processes. For example, the foam layer measuring system can minimize foam formation and/or the presence of foam within the container of the fluid processing system using a minimal amount of anti-foam solution (e.g., added to liquid and/or foam for reducing foam layer) and/or adjusting or activating one or more components of the fluid processing system. For example, one or more components can be controlled for reducing sparging or airflow into the container, reducing agitation (e.g., mechanical, acoustic, etc.) of the liquid, activating at least one foam breaker (e.g., mechanical, acoustic, surface rotatory, ultrasonic wave generator, etc.), and/or activating or adjusting other foam control mechanisms.

The systems and processes described herein can solve technical problems associated with bioproduction processes including growing, mixing, and suspension of cells and microorganisms inside various bioproduction equipment. More specifically, the foam layer measuring system can solve technical problems associated with foam layer formation above liquid in a mixing chamber for growing, mixing, and suspending cells and microorganisms inside various bioproduction equipment. The foam layer measuring system can solve the problem by calculating the thickness of the foam layer to determine whether the thickness satisfies a foam layer threshold. The foam layer threshold can be predefined and identify when the foam layer thickness is to be reduced. In response to determining the foam layer threshold is satisfied, an anti-foam solution can be added to the inner chamber and/or one or more components of the fluid processing system can be adjusted/activated to reduce the thickness of the foam layer.

Various data and configuration challenges can impede determining the thickness and/or volume of the foam layer and adding the proper amount of anti-foam solution to the inner chamber. For example, different quantities of bioproducts in the inner chamber make sensors coupled to an inside of the inner chamber or at the bioreactor insufficient to detect foam at various volumes of liquid and/or foam thicknesses. The foam layer measuring systems presented herein can detect changes to the foam thickness with precision to facilitate deployment of the minimum amount of anti-foam solution necessary to reduce or eliminate foam.

In some embodiments, the foam layer measuring system includes a container and a first sensor configured to measure at least one distance relative to the first sensor. In some embodiments, the foam layer measuring system further includes a second sensor, such as a sensor configured to measure a mass of a liquid in the container. In some embodiments, the second sensor can include an optical device and/or measure a distance relative to the second sensor. The foam layer measuring system can include a controller and a processor for performing various calculations, such as determine at least a thickness and/or volume of the foam layer. For example, the components of the foam layer measuring system can be arranged in a configuration for calculating the thickness and/or volume of the foam layer and for determining whether to add an anti-foam solution, as well as determine an appropriate amount of anti-foam solution to add. For example, the foam layer measuring system can determine the appropriate amount of anti-foam solution to dispense into the container for reducing and/or eliminating the foam layer based on the calculated thickness and/or volume of the foam layer. In some embodiments, the foam layer measuring system can use a proportional-integral-derivative (PID) control algorithm or a model predictive control algorithm to determine the appropriate amount of anti-foam solution to dispense.

In some embodiments, the foam layer measuring system includes a first sensor that includes a distance-measuring sensor (e.g., radar, Light Detection and Ranging (LiDAR) sensor, etc.) configured to measure a foam distance between a top foam surface of the foam layer and the first sensor, as well as a reference distance between a base of the inner chamber and the first sensor. In some embodiments, the first sensor can also measure a liquid distance between a top surface of the liquid and the first sensor. The foam layer measuring system can also include at least a second sensor for assisting with determining one or more aspects of the foam layer and/or liquid in the container. For example, the second sensor can assist with determining a thickness and/or volume of the foam layer, as well as a volume of the liquid in the container. The second sensor can also assist with determining an amount of coverage (e.g., percent coverage) of the foam layer along the top liquid surface. One or more dimensions of the container can be saved in the foam layer measuring system for assisting with determining one or more aspects of the foam layer and/or liquid.

In some embodiments, the second sensor can include at least one of a mass-measuring sensor and a pressure sensor for determining one or more aspects of the liquid and/or foam layer. For example, the second sensor can assist with determining a mass of the liquid contained in the container, such as by measuring the mass or pressure load of the container with and without the liquid. The processor can determine a difference between a measured mass or pressure load of the container when empty (e.g., does not contain liquid) and when containing the liquid. Such determined difference can be used, along with one or more dimensions of the container, to determine a volume and/or height of the liquid, as well as to determine a thickness and/or volume of the foam layer. For example, the height of the liquid can include a distance between a base of the inner chamber of the container and the top liquid surface. The thickness of the foam layer can include a distance between the top liquid surface and the top foam surface.

In some embodiments, the second sensor can include another distance-measuring sensor and/or an optical device (e.g., camera, video recorder, etc.). For example, the optical device can collect image data that can be analyzed by the foam layer measuring system for assisting with determining an amount of coverage of the top liquid surface by the foam layer. For example, the image data can be used to determine a percentage or fraction of the surface area of the top liquid surface that is covered by the foam layer, such as zero percent coverage to one-hundred percent coverage. For example, the foam layer measuring system can determine a volume of the foam layer using the determined thickness of the foam layer and an amount of coverage of the top liquid surface by the foam layer. More than one optical device can be included in the foam layer measuring system, and one or more optical devices can be positioned in a variety of locations. For example, at least one optical device can be positioned above the top liquid surface, such as to allow the at least one optical device to collect image data associated with the top liquid surface and/or foam layer. In some embodiments, one or more optical devices can be positioned along a side of the container, such as to allow the at least one optical device to collect image data associated with the height of the liquid and/or a thickness of the foam layer. For example, an embodiment of the container can include a viewing window along a side of the container through which at least a part of the liquid and/or foam layer can be viewed by at least one optical device. In some embodiments, at least one optical device positioned for collecting image data associated with the height of the liquid and/or thickness of the foam layer can be used to provide verification of the measured and/or calculated liquid height and/or foam layer thickness. For example, the image data can be used to display an image viewable by a user, such as for confirming that measured and/or calculated liquid height and foam layer thickness values are approximately the same as the liquid height and/or foam layer thickness viewable by the user. In some embodiments, the image data can be used for deriving measurements, such as liquid height and foam layer thickness.

In some embodiments, more than two sensors or sensing units can be included in the foam layer measuring system. For example, an embodiment of the foam layer measuring system can include a first sensor (e.g., distance-measuring sensor), a second sensor (e.g., mass-measuring sensor, pressure sensor, etc.), and a third sensor (e.g., optical device) that can assist with determining the thickness and/or volume of the foam layer. Other embodiments of the foam layer measuring system including a first sensor, a second sensor, and a third sensor (as well as embodiments including more or less than three sensors) are within the scope of this disclosure.

In some embodiments, the second sensor can include a second distance-measuring sensor that is configured to measure a liquid distance between the top liquid surface and the second sensor. In such a configuration, the first sensor can include a first distance-measuring sensor that is configured to measure a foam distance between the top foam surface and the first sensor. As such, the thickness of the foam layer can be determined based on a difference between the measured liquid distance taken by the second sensor and the measured foam distance taken by the first sensor. The volume of the foam layer can also be determined based on a diameter of the container and the determined foam layer thickness. Characteristics of the liquid, such as a density of the liquid, can be input and/or saved in the foam layer measuring system, such as for assisting with determining one or more measurements (e.g., liquid volume, liquid height, etc.).

In some embodiments, a single distance-measuring sensor can be used to determine both the height of the liquid and the thickness of the foam layer. For example, the single distance measuring sensor (e.g., radar) can be positioned above the top liquid surface, such as in a fixed position, and measure a distance between the single distance measuring sensor and the top liquid surface. Furthermore, the same distance measuring sensor can be used to measure a distance between a top foam surface of the foam and the distance measuring sensor. The same distance measuring sensor can be used to collect other measurements, such as distance between the distance measuring sensor and a bottom of a container that contains the liquid and/or foam layer. As such, measurements from the single distance measuring sensor can be used to determine liquid height and/or foam layer thickness, such as without data collected from other devices or sensors. For example, the single distance measuring sensor (e.g., radar) can provide different emission intensities and/or planned shifts in emission intensity in order to measure more than one distance (e.g., measure distance between radar and top liquid surface, as well as between radar and top foam surface). Other aspects of the single distance measuring sensor can be delivered and/or analyzed in order to measure more than one distance, such as the distance measuring sensor providing different emission frequencies and/or planned shifts in emission frequencies. Deconvolution and/or analysis of characteristic echo and/or return profiles delivered by the single distance measuring sensor can also be performed to determine more than one distance.

Embodiments of the foam layer measuring system described herein can be used in continuous processes and/or batch processes with different vessel sizes and/or liquid volumes and quantities in various vessel sizes. This can be advantageous over previous systems as manufacturers can implement the foam layer measuring system for use in a bioreactor for processing a variety of turn-down ratios. For example, the foam layer measuring system can enable a manufacturer to effectively process a small liquid batch size for an experimental bioproduct before increasing batch sizes for mass production. For example, the foam layering measuring system can measure foam thickness when the container (e.g., a bioproduction vessel) has any amount of liquid filling the container, such as measuring foam thickness when the container is approximately 5% filled with liquid (or less than 5% filled with liquid) to approximately 100% filled with liquid. In some embodiments, the distance-measuring sensor can be positioned at a variety of locations and distances away from the foam layer for measuring the foam layer thickness, such as less than 1 foot away from a top foam surface to approximately 30 feet away from the top foam surface. Other percent volumes and distances are within the scope of this disclosure.

Additionally, embodiments of the foam layer measuring system described herein can accommodate different bioproduct formulas having different tolerances for foam layer thickness and/or anti-foam solutions. The foam layer measuring system described herein can adjust, including dynamically, to various bioproduct formulas by adjusting foam layer thickness thresholds associated with the bioproduct formulas. For example, some bioproducts tolerate multiple inches of a foam layer interfering with oxygen transfer and/or large quantities of anti-foam solution. Other bioproducts are more sensitive to anti-foam solution and oxygen transfer interference and, for example, cannot tolerate more than an inch of foam layer thickness across the top surface of the bioproduct and/or can tolerate only a small quantity of anti-foam solution. In some embodiments the foam layer measuring system can allow a user to set and/or adjust foam parameters (e.g., acceptable foam layer thickness ranges) for one or more processing batches or runs. Additionally, the foam layer measuring system can perform observations and calculations that cannot readily be carried out by humans in typical vessels for bioproduction, due to limited size and quantity of viewing windows. For example, users with typical viewing windows to the inner chamber can be limited in their ability to detect changes to foam layer thickness and users can be unable to determine whether the thickness satisfies a foam layer threshold. As such, the foam layer measuring system can include several advantages over previous and/or currently available systems for reducing foam in processing and/or mixing systems, including systems for bioproduction equipment.

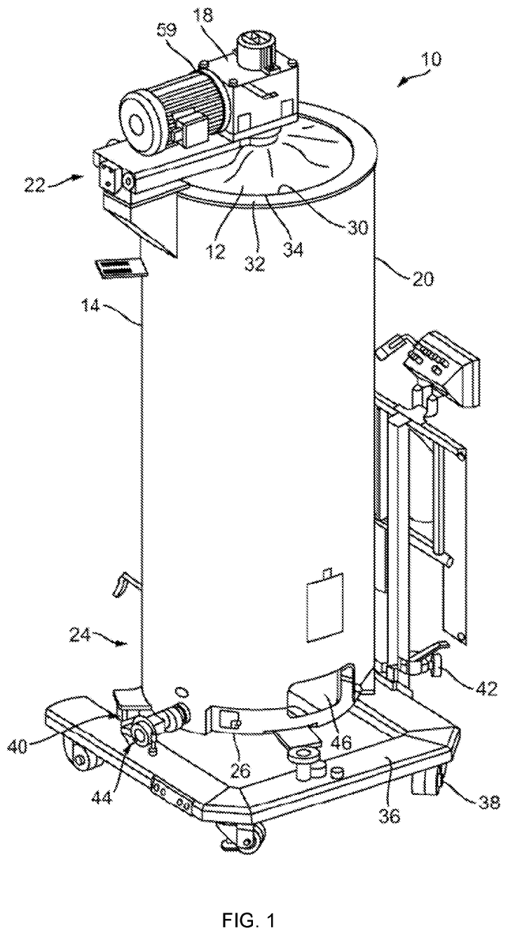

FIG. 1 illustrates an embodiment of a fluid processing system 10 incorporating features of the present disclosure. The fluid processing system 10 can be a mixer, reactor, fermenter or other bioproduction vessel used to process biological components. In general, processing system 10 comprises a container 12 that is disposed within a rigid support housing 14. A mixer system 18 is designed for mixing and/or suspending components within container 12. The various components of fluid processing system 10 will now be discussed in greater detail.

With continued reference to FIG. 1, support housing 14 has a substantially cylindrical sidewall 20 that extends between an upper end 22 and an opposing lower end 24. Lower end 24 has a floor 26 mounted thereto. Support housing 14 has an interior surface 28 that bounds a chamber 30. An annular lip 32 is formed at upper end 22 and bounds an opening 34 to chamber 30. Floor 26 of support housing 14 rests on a cart 36 having wheels 38. Support housing 14 is removably secured to cart 36 by connectors 40. Cart 36 enables selective movement and positioning of support housing 14. In alternative embodiments, however, support housing 14 need not rest on cart 36 but can rest directly on a floor or other structure.

Although support housing 14 is shown as having a substantially cylindrical configuration, in alternative embodiments support housing 14 can have any desired shape capable of at least partially bounding a compartment. For example, sidewall 20 need not be cylindrical but can have a variety of other transverse, cross-sectional configurations such as polygonal, elliptical, or irregular. Furthermore, it is appreciated that support housing 14 can be scaled to any desired size. For example, it is envisioned that support housing 14 can be sized so that chamber 30 can hold a volume of less than 50 liters or more than 1,000 liters. Support housing 14 is typically made of metal, such as stainless steel, but can also be made of other materials capable of withstanding the applied loads of the present invention.

In some embodiments, fluid processing system 10 is configured for regulating the temperature of the fluid that is contained within container 12 disposed within support housing 14. By way of example and not by limitation, electrical heating elements can be mounted on or within support housing 14. The heat from the heating elements can be transferred either directly or indirectly to container 12. Alternatively, in the depicted embodiment support housing 14 is jacketed with one or more fluid channels being formed therein. The fluid channels have a fluid inlet 42 and a fluid outlet 44 that enables a fluid, such as water or propylene glycol, to be pumped through the fluid channels. By heating, cooling or otherwise controlling the temperature of the fluid that is passed through the fluid channels, the temperature of support housing 14 can be regulated which, in turn, regulates the temperature of the fluid within container 12 when container 12 is disposed within support housing 14. Other conventional devices can also be used such as by applying gas burners to support housing 14 or pumping the fluid out of container 12, heating or cooling the fluid and then pumping the fluid back into container 12. When using container 12 as part of a bioreactor or fermenter, the means for heating can be used to heat the culture within container 12 to a temperature in a range between about 30 °C to about 40 °C. Other temperatures can also be used.

Support housing 14 can have one or more openings 46 formed on the lower end of sidewall 20 and on floor 26 to enable gas and fluid lines to couple with container 12 and to enable various probes and sensors to couple with container 12 when container 12 is within support housing 14. Further disclosure on support housing 14 and alternative designs thereof is disclosed in U.S. Pat. No. 7,682,067 and US Patent Publication No. 2011-0310696, which are incorporated herein by specific reference.

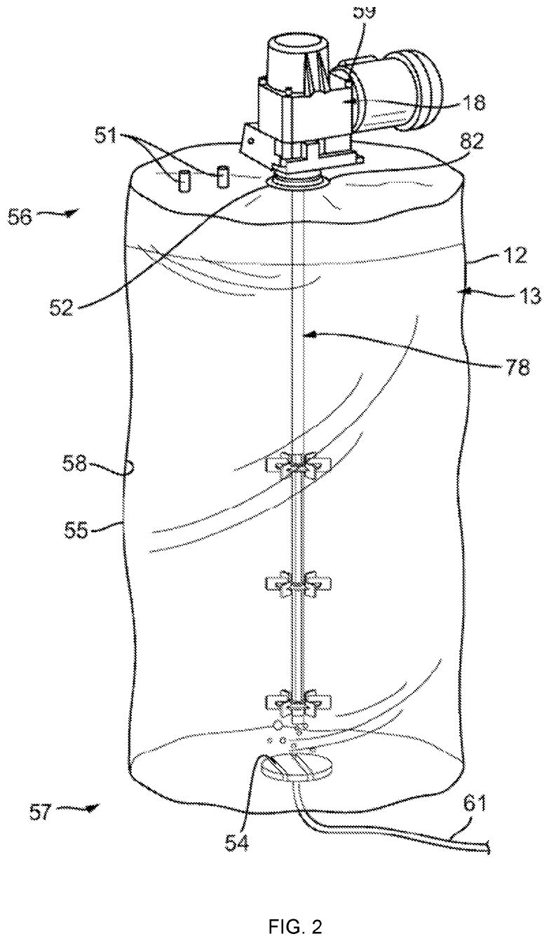

FIG. 2 shows container 12 coupled with mixer system 18. Container 12 has a side 55 that extends from an upper end 56 to an opposing lower end 57. Container 12 also has an interior surface 58 that bounds an inner chamber 13 in which a portion of mixer system 18 is disposed. In the embodiment depicted, container 12 comprises a flexible bag. Formed on container 12 are a plurality of ports 51 that communicate with the inner chamber 13. Although only two ports 51 are shown, it is appreciated that container 12 can be formed with any desired number of ports 51 and that ports 51 can be formed at any desired location on container 12 such as upper end 56, lower end 57, and/or alongside 55. Ports 51 can be the same configuration or different configurations and can be used for a variety of different purposes. For example, ports 51 can be coupled with fluid lines for delivering media, cell cultures, and/or other components into and out of container 12.

Ports 51 can also be used for coupling probes to container 12. For example, when container 12 is used as a bioreactor for growing cells or microorganisms, ports 51 can be used for coupling probes such as temperature probes, pH probes, dissolved oxygen probes, and the like. Examples of ports 51 and how various probes and lines can be coupled thereto is disclosed in United States Patent Publication No. 2006-0270036, published Nov. 30, 2006 and United States Patent Publication No. 2006-0240546, published Oct. 26, 2006, which are incorporated herein by specific reference. Ports 51 can also be used for coupling container 12 to secondary containers and to other desired fittings.

In one embodiment of the present invention, means are provided for delivering a gas into the lower end of container 12. By way of example and not by limitation, as also depicted in FIG. 2, a sparger 54 can be either positioned on or mounted to lower end 57 of container 12 for delivering a gas to the fluid within container 12. As is understood by those skilled in the art, various gases are typically required in the growth of cells or microorganisms within container 12. The gas typically comprises air that is selectively combined with oxygen, carbon dioxide and/or nitrogen. However, other gases can also be used. The addition of these gases can be used to regulate the dissolved oxygen and CO2 content and to regulate the pH of a culture solution. Depending on the application, sparging with gas can also have other applications. A gas line 61 is coupled with sparger 54 for delivering the desired gas to sparger 54. Gas line 61 need not pass through lower end 57 of container 12 but can extend down from upper end 56 or from other locations.

Sparger 54 can have a variety of different configurations. For example, sparger 54 can comprise a permeable membrane or a fritted structure comprised of metal, plastic or other materials that dispense the gas in small bubbles into container 12. Smaller bubbles can permit better absorption of the gas into the fluid. In other embodiments, sparger 54 can simply comprise a tube, port, or other type of opening formed on or coupled with container 12 through which gas is passed into container 12. In contrast to being disposed on container 12, the sparger can also be formed on or coupled with mixer system 18. Examples of spargers and how they can be used in the present invention are disclosed in United States Patent Publication Nos. 2006-0270036 and 2006-0240546 which were previously incorporated by reference. Other conventional spargers can also be used. It is appreciated that in some embodiments and uses that a sparger may not be required.

In the depicted embodiment, container 12 has an opening 52 that is sealed to a rotational assembly 82 of mixer system 18, which will be discussed below in greater detail. As a result, compartment 50 is sealed closed so that it can be sterilized and be used in processing sterile fluids. During use, container 12 is disposed within chamber 30 of support housing 14 as depicted in FIG. 1. Container 12 is supported by support housing 14 during use and can subsequently be disposed of following use. In one embodiment, container 12 is comprised of a flexible, water impermeable material such as a low-density polyethylene or other polymeric sheets or film having a thickness in a range between about 0.1 mm to about 5 mm with about 0.2 mm to about 2 mm being more common. Other thicknesses can also be used. The material can be comprised of a single ply material or can comprise two or more layers which are either sealed together or separated to form a double wall container. Where the layers are sealed together, the material can comprise a laminated or extruded material. The laminated material comprises two or more separately formed layers that are subsequently secured together by an adhesive.

The extruded material comprises a single integral sheet that comprises two or more layers of different materials that can be separated by a contact layer. All of the layers are simultaneously co-extruded. One example of an extruded material that can be used in the present invention is the Thermo Scientific CX3-9 film available from Thermo Fisher Scientific. The Thermo Scientific CX3-9 film is a three-layer, 9 mil cast film produced in a cGMP facility. The outer layer is a polyester elastomer coextruded with an ultra-low density polyethylene product contact layer. Another example of an extruded material that can be used in the present invention is the Thermo Scientific CX5-14 cast film also available from Thermo Fisher Scientific. The Thermo Scientific CX5-14 cast film comprises a polyester elastomer outer layer, an ultra-low density polyethylene contact layer, and an EVOH barrier layer disposed therebetween.

The material is approved for direct contact with living cells and is capable of maintaining a solution sterile. In such an embodiment, the material can also be sterilizable such as by radiation. Examples of materials that can be used in different situations are disclosed in U.S. Pat. No. 6,083,587 which issued on Jul. 4, 2000 and United States Patent Publication No. US 2003-0077466 A1, published Apr. 24, 2003, which are hereby incorporated by specific reference.

In one embodiment, container 12 comprises a two-dimensional pillow style bag wherein two sheets of material are placed in overlapping relation and the two sheets are bounded together at their peripheries to form the internal compartment. Alternatively, a single sheet of material can be folded over and seamed around the periphery to form the internal compartment. In another embodiment, the containers can be formed from a continuous tubular extrusion of polymeric material that is cut to length and is seamed closed at the ends.

In still other embodiments, container 12 can comprise a three-dimensional bag that includes an annular side wall, a two-dimensional top end wall, and a two dimensional bottom end wall. Three dimensional containers comprise a plurality of discrete panels, typically three or more, and more commonly four or six. Each panel is substantially identical and comprises a portion of the side wall, top end wall, and bottom end wall of the container. Corresponding perimeter edges of each panel are seamed together. The seams are typically formed using methods known in the art such as heat energies, RF energies, sonics, or other sealing energies.

In alternative embodiments, the panels can be formed in a variety of different patterns. Further disclosure with regard to one method of manufacturing three-dimensional bags is disclosed in United States Patent Publication No. US 2002-0131654 A1, published Sep. 19, 2002, which is hereby incorporated by reference.

It is appreciated that container 12 can be manufactured to have virtually any desired size, shape, and configuration. For example, container 12 can be formed having a compartment sized to 10 liters, 30 liters, 100 liters, 250 liters, 500 liters, 750 liters, 1,000 liters, 1,500 liters, 3,000 liters, 5,000 liters, 10,000 liters or other desired volumes. The size of the compartment can also be in the range between any two of the above volumes. Although container 12 can be any shape, in one embodiment container 12 is specifically configured to be complementary or substantially complementary to chamber 30 of support housing 14. It is desirable that when container 12 is received within chamber 30, container 12 is at least generally uniformly supported by support housing 14. Having at least general uniform support of container 12 by support housing 14 helps to preclude failure of container 12 by hydraulic forces applied to container 12 when filled with fluid.

Although in the above-discussed embodiment container 12 has a flexible, bag-like configuration, in alternative embodiments it is appreciated that container 12 can comprise any form of collapsible container, semi-rigid container, and/or rigid container. Container 12 can also be transparent or opaque and can have ultraviolet light inhibitors incorporated therein. In some embodiments, the container 12 can be contained in the housing 14 or the container 12 and housing 14 can be the same component (e.g., the container 14 can have a rigid body without a separate internal container, etc.)

Mixer system 18 is used for mixing and/or suspending a culture or other solution or suspension within container 12. As depicted in FIG. 2, mixer system 18 generally comprises a drive motor assembly 59 that is mounted on support housing 14 (FIG. 1), an impeller assembly 78 coupled to and projecting into container 12, and a drive shaft that extends between drive motor assembly 59 and impeller assembly 78.

As discussed above, mixing and/or sparging of liquids in the container 12 (e.g., bioreactor) can cause foam to form, such as above a liquid in the inner chamber 13 of the container 12. The foam can damage filters and hinder processing of the liquid and/or biological material. The present disclosure includes various embodiments of a foam layer measuring system that can determine measurements of foam formed above the liquid in the inner chamber 13. For example, the foam layer measuring system can include an embodiment of the fluid processing system 10 with one or more sensors and a controller (e.g., including a processor) for determining at least a thickness and/or a volume of a foam layer formed above the liquid.

For example, at least one of the sensors can continuously take measurements to allow the foam layer measuring system to continuously monitor and control foam levels (e.g., foam thickness, foam volume) in the inner chamber 13. The foam levels can be automatically controlled based on the continuous measurements. For example, the foam layer measuring system can continuously sense one or more measurements associated with the liquid and/or foam to thereby continuously determine a foam layer thickness in the inner chamber 13. Furthermore, the foam layer measuring system can assist with controlling the amount of foam in the container 12 by controlling a delivery of anti-foam solution in the inner chamber 13 and/or adjust/activate one or more components of the fluid processing system.

For example, the foam layer measuring system can determine and deliver an appropriate volume of anti-foam solution to the inner chamber 13 for effectively reducing the amount of foam in the inner chamber 13, such as when a threshold amount of foam is determined to be in the inner chamber 13. As such, the foam layer measuring systems described herein can provide improved monitoring and controlling of foam in fluid processing systems 10, which can avoid damage to the fluid processing systems (e.g., avoid damaging filters), improving liquid processing (e.g., reduce unwanted gas buildup and improve oxygen transfer at the liquid surface), and perform appropriate actions for reducing foam, such as deliver appropriate amounts (e.g., minimum necessary amount) of anti-foam solution (e.g., based on measured foam layer thickness). Various embodiments of the foam layer measuring system are described below.

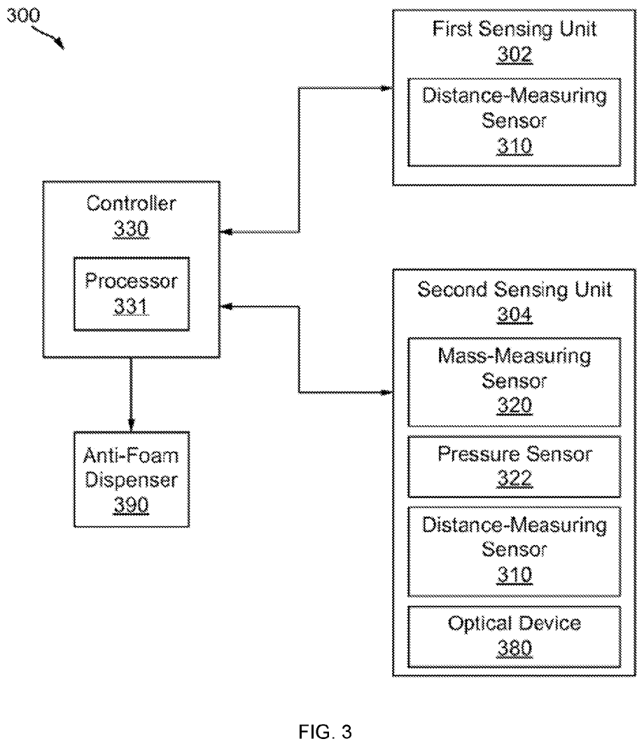

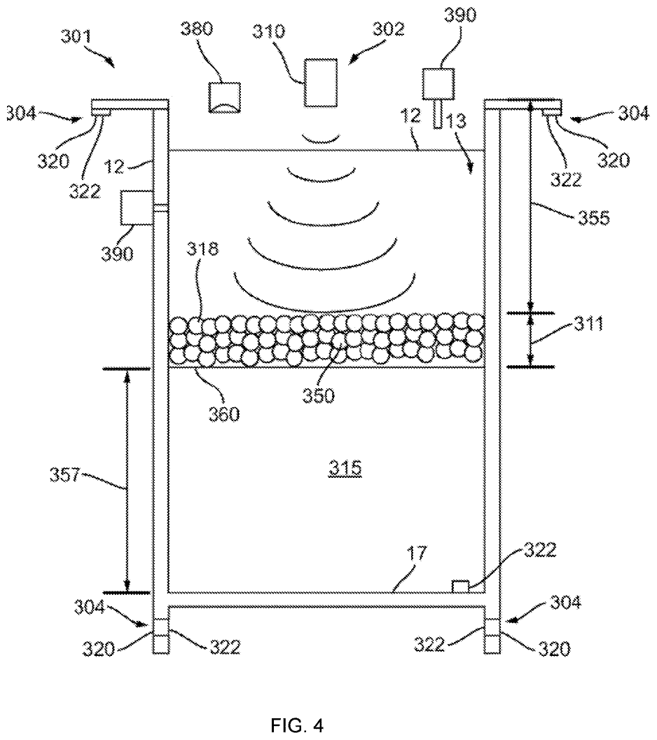

FIGS. 3 and 4 illustrate an embodiment of a foam layer measuring system 301 including foam layer measuring hardware 300 and an embodiment of the container 12 of the fluid processing system 10 according to an exemplary embodiment of the present disclosure. As shown in FIG. 4, the container 12 includes an embodiment of the inner chamber 13 configured to contain a liquid 315. As will be described in detail below, the foam layer measuring system 301 can be configured to determine a volume and/or thickness 311 of a foam layer 350 formed above the liquid 315 inside the inner chamber 13. For example, the thickness 311 of the foam layer 350 can be defined as extending between a top liquid surface 360 of the liquid 315 and a top foam surface 318 of the foam layer 350. The foam layer measuring system 301 can also determine a distance between a bottom of the inner chamber 13 and the top liquid surface 360 and/or the top foam surface 318.

FIG. 3 illustrates an embodiment of the foam layer measuring hardware 300 including a controller 330, a first sensing unit 302 (e.g., a first sensor), and a second sensing unit 304 (e.g., a second sensor) according to an exemplary embodiment of the present disclosure. The controller 330 can be communicatively coupled (e.g., directly or wirelessly) to the first sensing unit 302 and the second sensing unit 304. The controller 330 can include a processor 331. The processor 331 can include a non-transitory storage media storing instructions that, when executed by the at least one processor 331, cause the at least one processor 331 to perform operations, such as any of the operations disclosed herein. As shown in FIG. 3, the controller 330 can also be in communication with one or more anti-foam dispensers for controlling the anti-foam dispensers to deliver a desired amount of anti-foam (e.g., based on the determined volume and/or thickness of the foam layer) to the inner chamber 13 for reducing the amount of foam in the inner chamber. In some embodiments, the controller 330 can be in communication with one or more components of the fluid processing system 10, such as for adjusting/activating the one or more components to reduce the amount of foam in the inner chamber 13. For example, the controller 330 can be in communication with one or more components for reducing sparging or airflow into the container 12, reducing agitation (e.g., mechanical, acoustic, etc.) of the liquid 315, activating at least one foam breaker (e.g., mechanical, acoustic, surface rotatory, ultrasonic wave generator, etc.), and/or activating or adjusting other foam control mechanisms for reducing the amount of foam in the inner chamber 13.

In some embodiments, the first sensing unit 302 can include a distance-measuring sensor 310 configured to measure at least a foam distance 355 between the distance-measuring sensor 310 and the top foam surface 318 of the foam layer 350. For example, the first sensing unit 302 can be any sensor that is configured to emit an emission, such as an electromagnetic, radio or acoustic emission, and receive an echo emission for determining at least the foam distance 355. For example, the distance-measuring sensor 310 can be a radar sensor, a Light Detection and Ranging (LiDAR) sensor, an acoustic sensor, and/or the like. Other distance measurements can be taken with the distance-measuring sensor 310, such as a reference distance between the distance-measuring sensor 310 and the base 17 of the inner chamber 13 or container 12. The distance measurements taken by the distance-measuring sensor 310 can be collected at the controller 330 for analyzing and/or performing calculations, such as calculating a thickness 311 of the foam layer 350, as will be described in greater detail below.

In some embodiments, the second sensing unit 304 can sense one or more characteristics associated with the liquid 315 in order to determine a volume of the liquid 315 and/or determine a liquid level (e.g., a top liquid surface height of the liquid). For example, the measurements obtained by the second sensing unit 304 can be collected at the controller 330 for analyzing and/or performing calculations, such as calculating the volume of the liquid 315 and/or a second distance between the top liquid surface 360 and the base 17 of the container 12, which can be used to assist with determining a thickness 311 of the foam layer 350, as will be described below.

In some embodiments, the second sensing unit 304 includes a mass-measuring sensor 320 configured to measure at least a mass of the liquid 315 contained in the inner chamber 13. As shown in FIG. 4, the mass-measuring sensor 320 can include one or more load cells. The mass-measuring sensor 320 can be coupled to the container 12 and can be positioned below the container 12 such that the container 12 rests on the mass-measuring sensor 320, as shown in FIG. 4. As such, the mass-measuring sensor 320 (e.g., the load cells) can measure the mass of the container 12 and its contents (e.g., liquid 315 in inner chamber 13). In some embodiments, the mass-measuring sensor 320 can be coupled to an upper portion of the container, such as shown in FIG. 4. For example, the foam layer measuring system 301 can include at least one mass-measuring sensor 320 positioned adjacent a bottom portion of the container 12 and/or at least one mass-measuring sensor 320 positioned adjacent a bottom portion of the container 12.

For example, the mass of the container 12 can be determined by the mass-measuring sensor 320 prior to adding liquid 315 to the container 12 and stored in a memory at the controller 330. As such, measurements taken by the mass-measuring sensor 320 after liquid 315 is delivered to the container 12 can enable the controller 330 (e.g., processor 331) to determine the mass of the liquid 315, such as by subtracting the mass of the container 12 from mass measurements taken by the mass-measuring sensor 320 when the liquid 315 is contained in the container 12 (e.g., the difference equaling the mass of the liquid 315).

Additionally, the controller 330 can be configured to determine, based on the received measurements from the mass-measuring sensor 320, a volume of the liquid 315. For example, the density of the liquid 315 can be input and/or stored into a memory at the controller 330. For example, the density of the liquid 315 can be known, determined prior to the bioproduct cultivation, or determined based on a sample removed from the inner chamber 13 during the bioproduct cultivation. The controller 330 can use the density of the liquid 315, as well as the measured and/or determined mass of the liquid 315, to determine the volume of the liquid 315. The controller 330 can also receive and/or store one or more dimensions of the inner chamber 13 into a memory of the controller 330, such as a diameter, a radius, and/or a cross-sectional area of the inner chamber 13. As such, the controller 330 can use the one or more saved dimensions of the inner chamber 13 to determine a liquid height 357 (or second distance) in the inner chamber 13, as shown in FIG. 4. The liquid height 357 can be defined as the distance between the top liquid surface 360 and the base 17 of the inner chamber 13.

For example, the thickness 311 of the foam layer 350 can be determined by subtracting the determined liquid height 357 from the measured foam distance 355. As such, the foam layer measuring system 301 can determine the thickness 311 of the foam layer 350 without requiring human observation and measurements, which can at least reduce human error and/or costs, as well as enable automation and/or controls. Furthermore, the thickness of the foam layer 350 can be continuously determined by the controller 330, which can continuously obtain measurements from the first sensor and/or second sensor to calculate the thickness 311 of the foam layer 350. Such continuous sensing and calculating can enable the foam layer measuring system 301 to improve foam control, such as performing appropriate actions to reduce the foam layer 350, including adding appropriate or a minimum amount of anti-foam solution and/or control (e.g., adjust, activate, etc.) one or more components of the fluid processing system 10 necessary to reduce and/or eliminate the foam layer.

Furthermore, the foam layer measuring system 301 can effectively, continuously and automatically monitor and control foam levels at a variety of liquid volumes, including liquid volumes that change during processing of the liquid 315. For example, since the mass and/or volume of the liquid 315 is measured and determined, including continuously, such as for determining the thickness of the foam layer 350, the foam layer 350 can be determined at any liquid volume within the container 12. As such, small volumes of liquid 315 can be processed in relatively large volume containers and the thickness of foam can be determined and controlled.

In some embodiments, the second sensing unit 304 includes one or more pressure sensors 322 that can measure a pressure of the liquid 315. Similar to the mass measurements of the liquid 315, the controller 330 can use the measured pressure of the liquid 315 to determine a height of the liquid 315. As shown in FIG. 4, in some embodiments the pressure sensor 322 can be positioned along a base 17 of the container 12 for measuring a pressure of the liquid 315 in the container 12 (e.g., pressure exerted by a column height of the liquid 315). The controller 330 can determine the height of the liquid 315 by obtaining pressure measurements taken by the pressure sensor 322 and without requiring the dimensions of the container 12. For example, the pressure sensors 322 can include one or more hydrodynamic pressure sensors.

In some embodiments, the second sensing unit 304 (e.g., one or more pressure sensor 322 and/or mass-measuring sensor 320) can be positioned adjacent the top portion and/or the bottom portion of the inner chamber 13. For example, a first pressure sensor 322 can include a first hydrodynamic pressure sensor that is positioned adjacent the top portion of the inner chamber 13 and a second pressure sensor 322 can include a second hydrodynamic pressure sensor that is positioned adjacent a bottom portion of the inner chamber 13, such as shown in FIG. 4. Alternatively or in addition, a mass-measuring sensor 320 can be positioned adjacent the top portion and the bottom portion of the inner chamber 13, such as shown in FIG. 4. Other embodiments of the second sensing unit 304 can be positioned along and/or adjacent to various locations of the inner chamber 13 without departing from the scope of this disclosure. For example, the controller 330 can receive pressure and/or mass measurements and determine a volume and/or a height of the liquid 315 and/or foam layer 350 in the container 12, such as using other known dimensions/measurements (e.g., density of the liquid 315, one or more dimensions of the container 12, etc.).

In some embodiments, the first sensing unit 302 (e.g., the first sensor) and the second sensing unit 304 (e.g., the second sensor) can be the same sensor. For example, the first sensing unit 302 and the second sensing unit 304 can both include a radar sensor. For example, the first sensing unit 302 and the second sensing unit 302 can be the same device, such as a single distance-measuring sensor 310 having a single frequency emission. In such an embodiment, the single distance measuring sensor 310 can have an emission frequency and intensity (e.g., from radar sensor) that can be analyzed in combination with a characteristic echo curve (e.g., liquid echo curve and/or foam echo curve) in order to determine top surface distances of both the liquid and the foam (e.g., for determining foam layer thickness).

In some embodiments, the single distance-measuring sensor 310 can determine both the height of the liquid 315 and the thickness 311 of the foam layer 350. For example, the single distance measuring sensor 310 (e.g., radar) can be positioned above the top liquid surface 360, such as in a fixed position, and measure a distance between the single distance measuring sensor 310 and the top liquid surface 360. Furthermore, the same distance measuring sensor 310 can be used to measure a distance between a top foam surface 318 of the foam layer 350 and the distance measuring sensor 310. The same distance measuring sensor 310 can be used to collect other measurements, such as distance between the distance measuring senor 310 and the base 17 of the container 12. As such, measurements from the single distance measuring sensor 310 can be used to determine height of the liquid 315 and the thickness 311 of the foam layer 350, such as without data collected from other devices or sensors. For example, the single distance measuring sensor 310 (e.g., radar) can provide different emission intensities and/or planned shifts in emission intensity in order to measure more than one distance (e.g., measure distance between radar and top liquid surface 360, as well as between radar and top foam surface 318). Other aspects of the single distance measuring sensor 310 can be delivered and/or analyzed in order to measure more than one distance, such as the distance measuring sensor 310 providing different emission frequencies and/or planned shifts in emission frequencies. Deconvolution and/or analysis of characteristic echo and/or return profiles delivered by the single distance measuring sensor 310 can also be performed to determine more than one distance.

In some embodiments, the first sensing unit 302 and the second sensing unit 304 can be separate and the same type of device, such as both including a distance-measuring sensor 310 (e.g., both are radar sensors). For example, the first sensing unit 302 can include a first radar sensor having a frequency and intensity that is optimized for returning from the liquid (e.g., to determine distance between first sensing unit 302 and top surface of the liquid). Additionally, the second sensing unit 304 can include a second radar sensor having a frequency and intensity that is optimized for returning from the foam (e.g., to determine distance between second sensing unit 304 and top surface of the foam).

In some embodiments, the foam layer measuring system 301 can be configured to determine whether the determined thickness 311 of the foam layer 350 satisfies a foam layer threshold. For example, the foam layer threshold can be predefined and stored in memory at the controller 330. The foam layer threshold can define a thickness value that, once reached and/or exceeded, activates the controller 330 to perform steps to reduce the foam layer 350. For example, in some embodiments, the foam layer threshold is approximately one inch, two inches, five inches, or more than five inches. In some embodiments, when the foam layer threshold is satisfied (e.g., the foam thickness is determined to be at and/or exceeding the foam layer threshold), the controller 330 can perform one or more actions to reduce the foam layer 350, such as activate an anti-foam dispenser 390 for delivering a volume of anti-foam solution to the inner chamber 13 and/or adjust/activate one or more component of the fluid processing system 10 that results in reducing the foam layer. For example, one or more components can be adjusted/activated to reduce sparging or airflow into the container 12, reduce agitation (e.g., mechanical, acoustic, etc.) of the liquid 315, and/or activate at least one foam breaker (e.g., mechanical, acoustic, surface rotatory, ultrasonic wave generator, etc.).

In some embodiments, the controller 330 can include a control algorithm that improves control over the volume of the anti-foam solution that is added to the inner chamber 13 such that an appropriate amount of anti-foam is added based on the amount of foam present in the inner chamber 13. In some embodiments, a minimum volume or concentration of the anti-foam solution can be determined by and at the controller 330 and added to the inner chamber 13 to reduce the thickness 311 of the foam layer 350 by a specific or predetermined amount. The minimum reduction in the thickness 311 of the foam layer 350 can be input and stored at the controller 330, and in various embodiments can be one inch, two inches, five inches, or more than five inches of reduction in the thickness 311 of the foam layer 350. In some embodiments, the volume of the anti-foam solution added to the inner chamber 13 is based on a timed dosing control algorithm or a height threshold dosing control algorithm. In some embodiments, the volume of the anti-foam solution added to the inner chamber 13 is based on at least one of a proportional-integral-derivative (PID) control algorithm or a model predictive control algorithm. For example, the volume of anti-foam solution needed to effectively reduce the foam in the inner chamber 13 can be determined based on the calculated thickness 311 of the foam layer 350, the diameter of the inner chamber 13 (e.g., to determine a volume of foam), or another dimension of the inner chamber 13.

The controller 330 can be configured to continuously monitor the thickness 311 of the foam layer 350 in the inner chamber 13. In some embodiments, the controller 330 can be configured to monitor the thickness 311 of the foam layer 350 at intervals. In some embodiments, the controller 330 can monitor the thickness 311 of the foam layer 350 at intervals and increase the rate of sampling and monitoring in response to the intensity of the gassing, sparging, agitation, and/or the intensity (e.g., rotations per minute or angle) of the mixing. In some embodiments, the controller 330 can monitor the thickness 311 of the foam layer 350 at intervals and increase the rate of sampling and monitoring in response to microbial cultivation.

In some embodiments, the foam layer measuring system 301 can include at least one optical device 380 (e.g., video recorder, camera, LiDAR) directed into the inner chamber 13, as shown in FIG. 4. For example, the optical device 380 can be directed at the top foam surface 318 of the foam layer 350 and/or the top liquid surface 360 of the liquid 315, as shown in FIG. 4. In some embodiments, the controller 330 can be in communication with the optical device 380, as shown in FIG. 3, and receive image data from the optical device 380, which can be used to determine foam layer volume and/or foam layer thickness 311. For example, the optical device 380 can capture an amount of a surface area of the top liquid surface 360 that is covered by the foam layer 350, which can be captured in the image data provided to the controller 330. The controller 330 can analyze the image data (e.g., the amount of surface area of the top liquid surface 360 covered by the foam layer 350) to determine foam layer volume and/or foam layer thickness 311. In some embodiments, more than one optical device 380 can be directed at the top foam surface 318 and/or the top liquid surface 360, and each optical device 380 can provide image data to the controller 330. For example, the controller 330 can analyze the image data from each optical device 380 to determine one or more average calculations, such as an average foam volume and/or an average percent coverage of the foam layer 350 covering the top liquid surface 360. In some embodiments, a regression can be used to correlate a foam layer coverage of the top liquid surface 360 based on a determined foam layer thickness 311. In some embodiments, the first sensing unit 302 can include one or more distance-measuring sensors 310 and the second sensing unit 304 can include one or more optical devices 380 for determining foam thickness 311 and/or foam volume, such as for determining a minimum amount of anti-foam solution necessary to reduce or eliminate foam.

More than one optical device 380 can be included in the foam layer measuring system 301, and one or more optical devices 380 can be positioned in a variety of locations. For example, at least one optical device 380 can be positioned above the top liquid surface 360, such as to allow the at least one optical device 380 to collect image data associated with the top liquid surface 360 and/or foam layer 350. In some embodiments, one or more optical devices 380 can be positioned along a side of the container 12, such as to allow the at least one optical device 380 to collect image data associated with the height of the liquid 315 and/or a thickness 311 of the foam layer 350. For example, an embodiment of the container 12 can include a viewing window (e.g., formed of translucent material) along a side of the container 12 through which at least a part of the liquid 315 and/or foam layer 350 can be viewed by at least one optical device 380. In some embodiments, at least one optical device 380 positioned for collecting image data associated with the height of the liquid 315 and/or thickness 311 of the foam layer 350 can be used to provide verification of the measured and/or calculated liquid height and/or foam layer thickness. For example, the image data can be used to display an image viewable by a user, such as for confirming measured and/or calculated liquid height and foam layer thickness values are approximately the same as the liquid height and/or foam layer thickness viewable by the user. In some embodiments, the image data can be used for deriving measurements, such as liquid height and foam layer thickness.

As shown in FIG. 4, one or more anti-foam dispensers 390 can be positioned along and/or adjacent to the inner chamber 13, such as positioned along and/or coupled to a sidewall of the container 12. For example, the anti-foam dispenser 390 can direct anti-foam in one or more directions, such as at an angle and/or perpendicular to the foam layer (e.g., in a spray formation). In some embodiments, one or more anti-foam dispensers 390 can be positioned along a top portion of the container 12 such that the anti-foam dispenser directs anti-foam down towards the foam layer (e.g., in a spray formation). Any number of anti-foam dispensers 390 can be positioned along and/or adjacent to the container 12 and in communication with the controller 330, as shown in FIG. 3, to allow the controller 330 to control a volume of anti-foam delivered to the inner chamber 13 for at least reducing the foam layer. For example, the volume of anti-foam delivered to the inner chamber 13 can be controlled by the controller 330 and based on a determined volume of anti-foam that is sufficient to reduce the foam layer (e.g., based on determined foam layer thickness and/or volume).

In some embodiments, the composition of the liquid 315 can be determined and/or analyzed in order to determine the volume of anti-foam that is appropriate to reduce the foam layer 350. For example, a volume of gas or gas bubbles can be held up in the liquid 315 (e.g., gas holdup volume), such as during sparging of the liquid 315 (e.g., using sparger 54 shown in FIG. 2). The gas holdup volume can include gas bubbles in the liquid 315 that are not stable and readily leave the liquid 315. When the gas bubbles are in the liquid 315, the gas bubbles can cause the height of the liquid 315 to increase. For example, such increase in liquid height can affect the thickness 311 determinations of the foam layer 350 if the gas holdup volume is not accounted for. As such, the controller 330 can determine the gas holdup volume in the liquid 315 using one or more ways, such as described herein.

In some embodiments, the gas holdup volume can be calculated based on a gas bubble rise velocity through the liquid 315 (e.g., a function of gas bubble size), a height of the liquid 315, and a flow rate of the gas being delivered to the liquid 315. For example, data modeling can be used to calculate the gas holdup volume using one or more of a variety of characteristics of the fluid processing system 10, such as a pore size of the sparger 54 (e.g., effects gas bubble size), one or more container 12 dimensions, a height of the liquid 315 (e.g., either with or without a gas holdup volume), and a flow rate of the gas in to the liquid 315 (e.g., sparger rate). For example, a mass flow meter (e.g., component of a mass flow controller associated with the sparger 54) can be used to determine the flow rate of the gas into the liquid 315. Any of the sensors and confirmations described herein can be used to assist with determining the gas holdup volume, such as for determining the height of the liquid either with or without a gas holdup volume.

In some embodiments, the gas holdup volume can be calculated based on a discrepancy between a determined liquid height based on a visual determination and/or a liquid height/distance measurement (e.g., radar, optical, etc.) and a determined liquid height based on a measured mass of the liquid (e.g., using load cells, volume of liquid calculated using density of un-gassed liquid, etc.). As described above, the liquid 315 having a gas holdup volume can have a greater height and thus the visual determination and/or liquid height/distance measurement can be greater than the determined liquid height based on the measured mass of the liquid 315. A difference between the two determined liquid heights can be used to determine the gas holdup volume. In some embodiments, one or more sensors can be used to compare liquid heights before and during sparging of the liquid. The difference between the liquid heights before and during sparging can be used to determine the gas holdup volume.

In some embodiments, at least one of the distance-measuring sensor 310 and the mass-measuring sensor 320 can be coupled to the container 12 and/or positioned within the inner chamber 13. The container 12 can be a rigid shell, steel tank, a tote, and/or other chamber capable of holding biological components. The inner chamber 13 can include an empty portion of the container 12, a plastic bag in the container 12, or another material having a plastic viewing window for the distance-measuring sensor 310.

As discussed above, the distance-measuring sensor 310 can be a radar sensor that is configured to be positioned outside of the inner chamber 13. At least one benefit with having the distance-measuring sensor 310 being a radar sensor is that the radar sensor can obtain distance measurements through some materials forming the container 12 (e.g., plastic material) thereby allowing the distance-measuring sensor 310 to be positioned outside the inner chamber 13. Positioning the distance-measuring sensor 310 outside the inner chamber 13 prevents contamination by the distance-measuring sensor 310 and/or eliminates added steps to sanitize the distance-measuring sensor 310 before placing within the inner chamber 13. As such, maintaining aseptic conditions in the inner chamber 13 and liquid processing efficiency can be more easily achieved with the distance-measuring sensor 310 including a radar sensor.

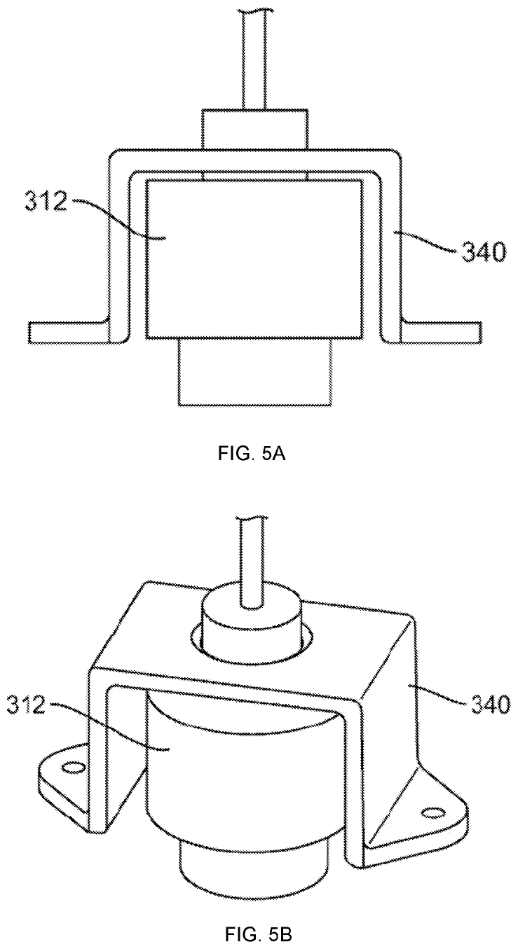

FIGS. 5A and 5B illustrate an embodiment of the distance-measuring sensor 310 including a radar sensor 312. As shown in FIGS. 5A and 5B, the radar sensor 312 can be coupled to a mounting bracket 340 that is configured to couple to a location relative to the inner chamber 13, such as along an upper portion of the container 12 (e.g., a lid or covering of the container 12). In some embodiments, the mounting bracket 340 can be removably coupled to a part of the system such that the radar sensor 312 can be removably coupled (e.g., for single-use with the container 12). As such, the mounting bracket 340 can secure a positioning of the radar sensor 312 relative to the container 12, including at least relative to the liquid 315 and foam layer 350 within the container 12. For example, the mounting bracket 340 can assist with positioning the radar sensor 312 such that it is directed straight down towards the liquid 315 (e.g., top liquid surface) and foam layer 350 (e.g., top foam surface) and/or able to direct radar emissions through one or more parts of the container 12 (e.g., plastic lid and/or covering, etc.). Other mechanisms can be used to position the radar sensor 312 in a preferred orientation and location, such as relative to the liquid and foam layer. For example, one or more of a variety of mounting bracket embodiments, adjustable mechanical arms, securing footplates, etc., can be used to permanently or releasably secure a position of the radar sensor 312. Other devices and mechanisms for positioning the radar sensor 312 are within the scope of this disclosure.

The radar sensor 312 can be configured to emit a radio emission that passes through the container 12 and into the inner chamber 13 to detect the top surface of the foam layer 350. For example, the inner chamber 13 can include a bag containing the liquid (e.g., bioproduct or biological components). As discussed above, the emission of the radar sensor 312 can pass through materials forming the container. For example, the radar sensor 312 emissions can pass through the container 12 defining the inner chamber 13 and detect the top foam surface 318 of the foam layer 350 (e.g., for determining the foam distance 355). As such, the top portion of the container 12 can be formed of a material that is radar transparent. The characteristics (e.g., time delay) of the echo of the radio emission from the top foam surface 318 of the foam layer 350 can correlate to the distance between the radar sensor 312 and the top foam surface 318 of the foam layer 350. For example, emissions from the radar sensor 312 can include approximately 80 gigahertz (GHz) electromagnetic frequency emissions. Other emission frequencies and/or electromagnetic waves are within the scope of this disclosure, such as radio waves, microwaves, and/or gamma rays.

The radar sensor 312 can continuously obtain measurements associated with the foam distance 355. For example, the radar sensor 312 can be configured to detect any fluctuation in the top foam surface 318 of the foam layer 350 over time. The controller 330 communicatively coupled to the radar sensor 312 can be configured to receive the measurements of the radar sensor 312 and, for example, average two or more measurements to determine an average rate of change of the top foam surface 318 of the foam layer 350. In some embodiments, the controller 330 can be configured to identify a trend in the distance measurements of the radar system. The controller 330 can extrapolate the trend formed from distance measurements to determine whether the anti-foam solution should be added to prevent the thickness 311 of the foam layer 350 from exceeding the foam layer threshold and/or one or more component of the fluid processing system 10 should be activated/adjusted to reduce the thickness 311 of the foam layer 350. In some embodiments, the foam distance 355 is based on two or more measurements by the distance-measuring sensor 310.

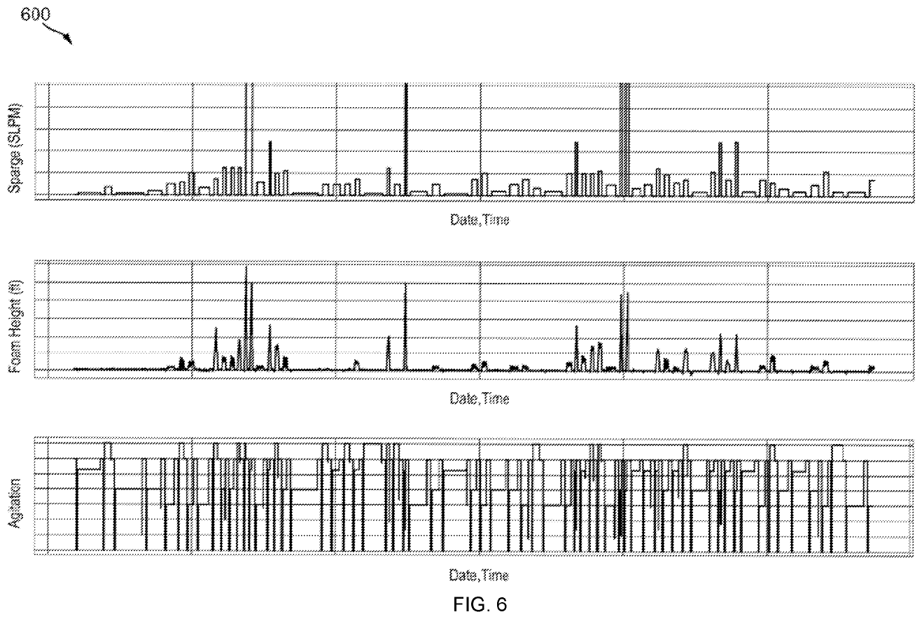

FIG. 6 illustrates a foam layer thickness graph 600 showing a correlation between agitating and sparging process fluid containing biological components and the thickness 311 of the foam layer 350 according to exemplary embodiments of the present disclosure. The sparge graph measures the gas flow or the airflow coming into the container 12. The agitation graph measures the stirring rate in revolutions per minute of the process fluid. The middle graph depicts the thickness of the foam over the same time period as the sparge graph and the agitation graph. As shown, a correlation exists between at least the sparging of process fluid and the thickness of the foam layer 350. For example, as sparging increases, the thickness of the foam layer 350 can increase. Agitation can also contribute to thickness of the foam layer 350.

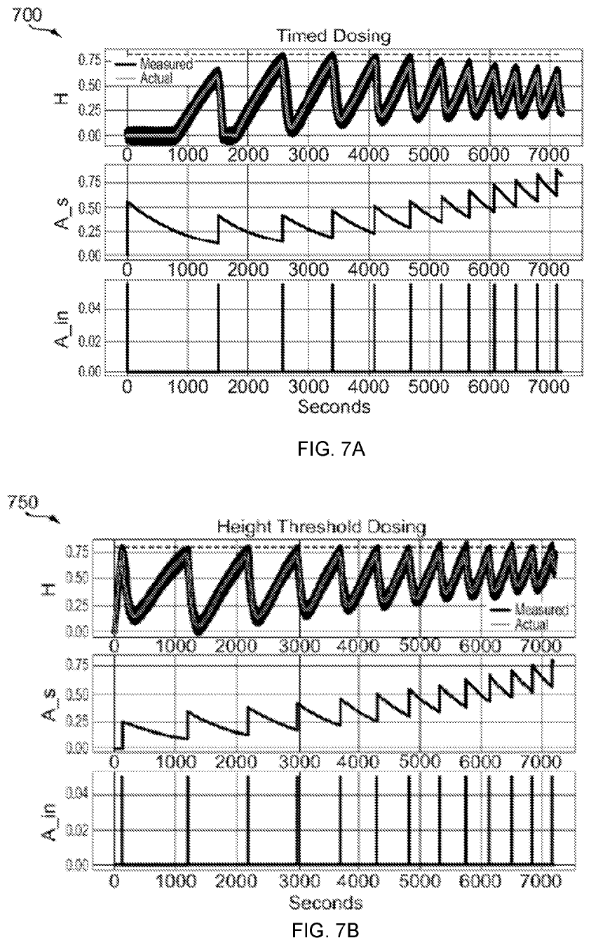

FIG. 7A illustrates a timed dosing control graph 700 showing an example timed dosing control method for maintaining the thickness 311 of the foam layer 350 according to exemplary embodiments of the present disclosure. The timed threshold dosing method can be configured to add the anti-foam solution at a regular schedule when a time threshold is satisfied. The time threshold dosing method applies anti-foam solution at time intervals and applies the anti-foam solution with respect to time at which the previous dose was applied.

FIG. 7B illustrates a first height threshold dosing control graph 750 showing an example height threshold dosing control method for maintaining a thickness 311 of the foam layer 350 according to exemplary embodiments of the present disclosure. The height threshold dosing method is configured to add the anti-foam solution when a height threshold is satisfied. The height threshold dosing method applies anti-foam solution at intervals and applies the anti-foam solution irrespective of the time at which the previous dose was applied or the overall number of doses applied.

FIG. 7C illustrates a second height threshold dosing control graph 775 showing another example height threshold dosing control method for maintaining a thickness 311 of the foam layer 350 according to exemplary embodiments of the present disclosure. For example, the thickness 311 of the foam layer 350 can be maintained as shown in FIG. 7C using any of the foam layer measuring system 301 embodiments disclosed herein.

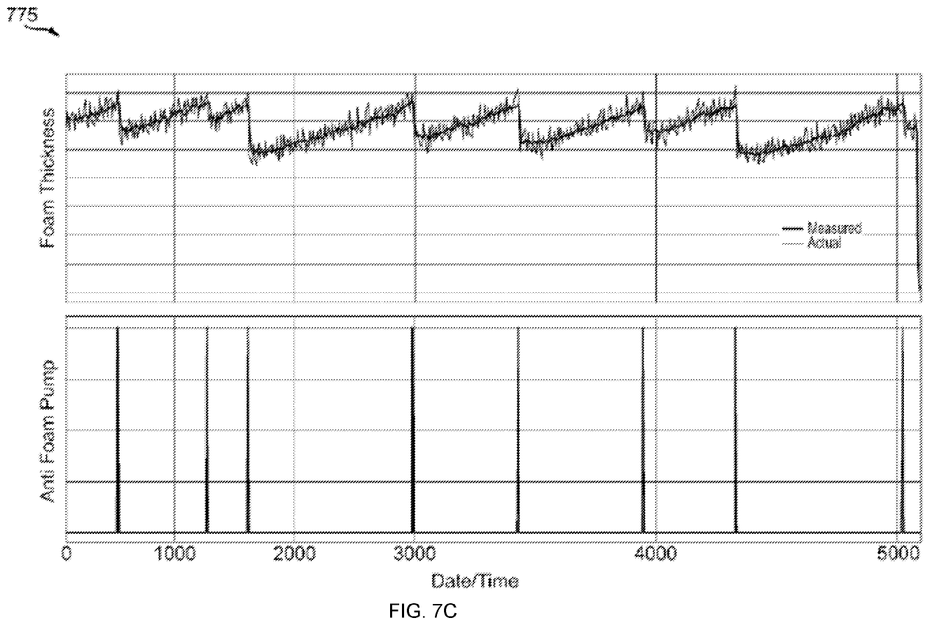

FIG. 8A illustrates a PID control graph 800 showing an example proportional-integral-derivative (PID) control for maintaining a thickness 311 of the foam layer 350 according to exemplary embodiments of the present disclosure. The PID control method is a time-dependent response that can be used to maintain the foam level thickness at a specific height, minimize the amount of anti-foam solution needed to maintain the thickness 311 of the foam layer 350. The PID control method garners improved control and reduces the total anti-foam solution used, such as compared to the timed dosing and height dosing models. The PID control method analyzes instantaneous measurements, a culmination of measurements over a period of time, and the reactions of the thickness 311 of the foam layer 350 in response to the added anti-foam solution. The duty cycle and the gain can be adjusted to determine a more accurate control over the thickness 311 of the foam layer 350 and to minimize overshooting and undershooting associated with maintaining the thickness 311 of the foam layer 350 at a predetermined level.

FIG. 8B illustrates a model predictive control graph 850 showing an example model predictive control for maintaining a thickness 311 of the foam layer 350 according to exemplary embodiments of the present disclosure. The model predictive control method is a time-dependent response that can be used to maintain the thickness 311 of the foam layer 350 at a specific height and to minimize the amount of anti-foam solution needed to maintain the thickness 311 of the foam layer 350. The model predictive control method garners improved control and reduces the total anti-foam solution used, such as compared to PID control. The model predictive control method can predict how adding anti-foam solution now will affect the thickness 311 of the foam layer 350. In some embodiments, the model predictive control method adds more anti-foam solution near the beginning of the stirring process and adds minimal amounts of anti-foam solution after the initial stirring process to keep the thickness 311 of the foam layer 350 stable.

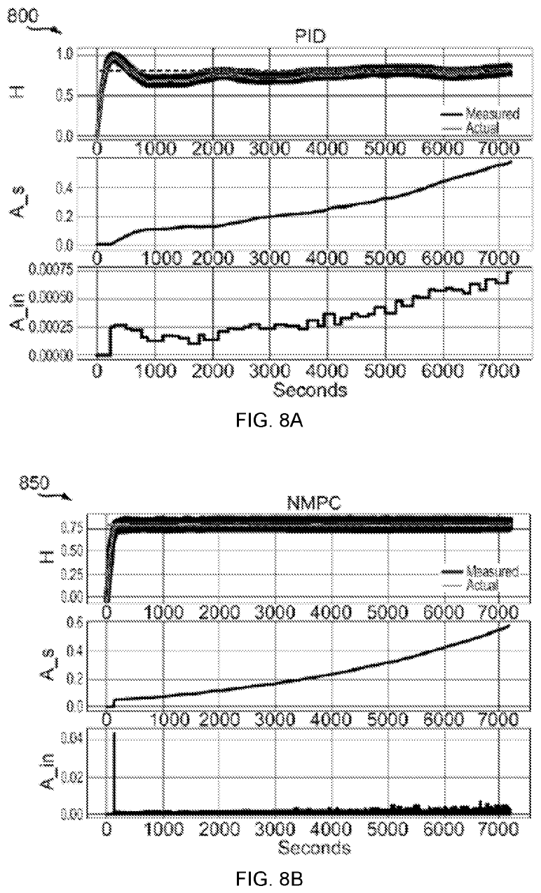

FIG. 9 illustrates anti-foam consumption graph 900 based on anti-foam application controls according to exemplary embodiments of the present disclosure. The choice of control method for applying the anti-foam solution affects the total amount of consumed anti-foam solution. For example, the timed dosing control method requires more anti-foam solution than the height threshold dosing control method. In another example, the height threshold dosing control method consumes more anti-foam solution than the PID control method. In another example, the PID control method consumes more anti-foam solution than the model predictive control. Complex control methods can enable real-time and predictive control and allow for optimized foam control responses, such as delivery of anti-foam.

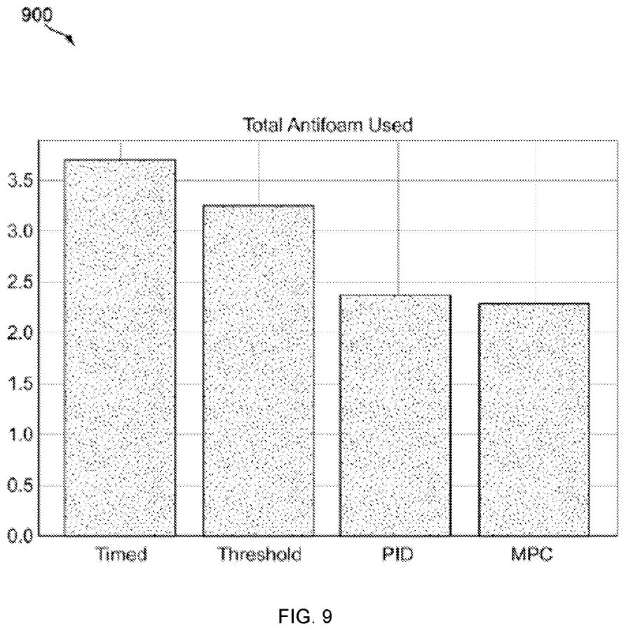

FIG. 10 illustrates a foam layer control process 1100 according to exemplary embodiments of the present disclosure. The foam layer control process 1100 can be performed by a foam layer measuring system 301 that includes at least an embodiment of the container 12, distance-measuring sensor 310 (e.g., the first sensor or first sensing unit 302), mass-measuring sensor 320 (e.g., the second sensor or second sensing unit 304), processor 331, and non-transitory storage medium (e.g., of controller 330). The distance-measuring sensor 310 can be positioned adjacent to a top portion of the inner chamber 13. The distance-measuring sensor 310 can be configured to measure a foam distance 355 between a top foam surface 318 of the foam layer 350 and the distance-measuring sensor 310. The mass-measuring sensor 320 can be coupled to the container 12, and the mass-measuring sensor 320 can be configured to measure a mass of the liquid 315 in the inner chamber 13 of the container 12. The controller 330 can be configured to perform at least the following operations.

At 1102, the controller 330 can obtain a reference distance between a base of the inner chamber 13 and the first sensor from the first sensing unit 302. For example, the distance-measuring sensor 310 can obtain a measurement of the distance to the base 17 of the inner chamber 13 from the distance-measuring sensor 310.

At 1104, the controller 330 can obtain a foam distance 355 between the top foam surface 318 of the foam layer and the first sensor from the first sensing unit 302. For example, the distance-measuring sensor 310 can obtain a measurement of the distance to the base 17 of the inner chamber 13 from the distance-measuring sensor 310.

At 1106, the controller 330 can calculate a first distance based on the difference between the foam distance 355 and the reference distance. The first distance can be indicative of the distance from the top foam surface 318 and the base 17 of the inner chamber 13. For example, the controller 330 can subtract the foam distance 355 from the reference distance to obtain the first distance indicative of the distance from the top foam surface 318 and the base 17 of the inner chamber 13.

At 1108, the controller 330 can determine the volume of the liquid 315 in the inner chamber 13 based on the mass of the container 12 having the inner chamber 13 with the liquid 315. For example, measurements taken by the mass-measuring sensor 320 can enable the controller 330 (e.g., processor 331) to determine the mass of the liquid 315. The controller 330 can subtract the mass of the container 12 from mass measurements taken by the mass-measuring sensor 320 when the liquid 315 is contained in the container 12 (e.g., the difference equaling the mass of the liquid 315). The controller 330 can use the density of the liquid 315, as well as the measured and/or determined mass of the liquid 315, to determine the volume of the liquid 315.

At 1110, the controller 330 can determine the top liquid surface 360 in the inner chamber based on the volume of the liquid in the inner chamber. For example, the controller 330 can also have one or more dimensions of the inner chamber 13 stored in a memory. The controller 330 can use the one or more saved dimensions of the inner chamber 13 to determine a liquid height 357 (or second distance) in the inner chamber 13. The liquid height 357 can be defined as the distance between the top liquid surface 360 and the base 17 of the inner chamber 13.

At 1112, the controller 330 can calculate the thickness 311 of the foam layer 350 by determining the difference between the first distance and the liquid height 357. For example, the controller can subtract the liquid height 357 from the first distance to obtain the thickness 311 of the foam layer 350.

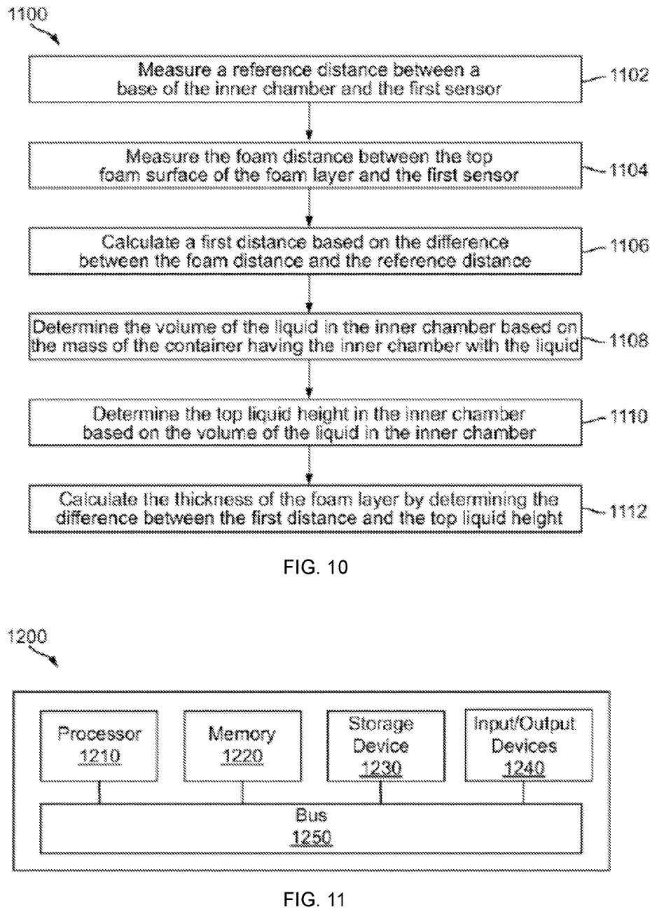

FIG. 11 illustrates a block diagram depicting an example of a computing system 1200 consistent with implementations of the current subject matter.

The computing system 1200 can be used to implement the foam layer measuring system 301 and/or any component therein. For example, the computing system 1200 can implement user equipment, a personal computer, or a mobile device.

As shown in FIG. 11, the computing system 1200 can include a processor 1210, a memory 1220, a storage device 1230, and an input/output device 1240. The processor 1210, the memory 1220, the storage device 1230, and the input/output device 1240 can be interconnected via a system bus 1250. The processor 1210 is capable of processing instructions for execution within the computing system 1200. Such executed instructions can implement one or more components of, for example, the foam layer measuring system 301 for calculating a thickness 311 of the foam layer 350 and determining whether a foam layer threshold is satisfied. In some example embodiments, the processor 1210 can be a single-threaded processor. Alternately, the processor 1210 can be a multi-threaded processor. The processor 1210 is capable of processing instructions stored in the memory 1220 and/or on the storage device 1230 to display graphical information for a user interface provided via the input/output device 1240.

The memory 1220 is a non-transitory computer-readable medium that stores information within the computing system 1200. The memory 1220 can store data structures representing configuration object databases, for example. The storage device 1230 is capable of providing persistent storage for the computing system 1200. The storage device 1230 can be a floppy disk device, a hard disk device, an optical disk device, or a tape device, or other suitable persistent storage means. The input/output device 1240 provides input/output operations for the computing system 1200. In some example embodiments, the input/output device 1240 includes a physical or virtual keyboard and/or pointing device. In various implementations, the input/output device 1240 includes a display unit for displaying graphical user interfaces. The display unit can be a touch activated screen that displays and facilitates user input/output operations.

According to some example embodiments, the input/output device 1240 can provide input/output operations for a network device. For example, the input/output device 1240 can include Ethernet ports or other networking ports to communicate with one or more wired and/or wireless networks (e.g., a local area network (LAN), a wide area network (WAN), the Internet, a public land mobile network (PLMN), and/or the like). Other communication protocols can include analog, digital and/or other communication signals.

In some example embodiments, the computing system 1200 can be used to execute various interactive computer software applications that can be used for organization, analysis, and/or storage of data in various formats. Alternatively, the computing system 1200 can be used to execute any type of software applications. These applications can be used to perform various functionalities, e.g., planning functionalities (e.g., generating, managing, editing of spreadsheet documents, word processing documents, and/or any other objects, etc.), computing functionalities, communications functionalities, etc. The applications can include various add-in functionalities or can be standalone computing items and/or functionalities. Upon activation within the applications, the functionalities can be used to generate the user interface provided via the input/output device 1240. The user interface can be generated and presented to a user by the computing system 1200 (e.g., on a computer screen monitor, etc.).

In some cases, fluid processing systems 10 described herein can comprise one or more components useful in performing monitoring and/or control of foam levels in the systems using feedback. In some cases, the feedback can be real time feedback from one or more sensors of the system. Systems configured to monitor and/or control foam level based, at least in part, on feedback from one or more sensors of the system can significantly reduce the frequency and/or magnitude of increases (e.g., unintended transient increases) in foam level during system operation. Increases in foam level (e.g., foam thickness 311) can occur quickly enough in existing culture systems that correction before increased foam level becomes problematic can be difficult. Systems configured to monitor and/or control foam level based, at least in part, on feedback from one or more sensors of the system can also accurately maintain foam level at one or more specified levels (e.g., threshold values) even in situations where the volume of fluid in the culture system increases or decreases, for instance, wherein the culture volume increases with cellular growth in the culture. Systems configured to monitor and/or control foam level based, at least in part, on feedback from one or more sensors of the system (e.g., one or more of distance-measuring sensor 310 or mass-measuring sensor 320) can also allow for or facilitate different methods or combinations of methods of foam control intervention. For instance, a system described herein can be configured to employ one or more methods or combinations of methods of foam control intervention at two or more foam threshold levels. Such configuration can be advantageous in cases where an initial anti-foam intervention does not slow or stop foam level increase or does not slow or stop foam level increase quickly enough to avert foam-related system problems.

As described herein, an optical device (e.g., radar sensor) can be used to measure a distance from the sensor to the top of the foam of a bioreactor culture. The measured distance 355 from the sensor to the top of the foam can be used to determine a measured foam thickness value 311. Foam height can be calculated by comparing a measured foam thickness value 311 to a reference foam thickness value. In some embodiments, a reference foam thickness value can be a distance measured to the top of the foam or to the top of the fluid in the bioreactor container chamber, at a reference time point (e.g., at the beginning of culture). In some embodiments, a foam thickness 311 calculated based on optical sensor data can be adjusted based on the volume of fluid in the bioreactor container 12. A controller 330 can be useful in adjusting a foam thickness determined based on the volume of the fluid 315 in the bioreactor container 12. In some cases, a constant reference value can be used to determine the volume of a fluid in the bioreactor container 12. A constant value for fluid volume can be based on a known volume of fluid added to the bioreactor container 12 at the outset of bioreactor use.

In some embodiments, a fluid volume value can be determined based on a weight of the bioreactor container chamber or, optionally, after adjustment using a fluid density factor. In some embodiments, the density of the fluid can be assumed to be the density of water. In some embodiments, a density of the fluid can be assumed to be a pre-determined average density of the culture components. In some embodiments, a non-constant value for fluid volume can be used in the calculation foam thickness 311. For example, a rate of increase in fluid volume can be used to determine or estimate a real-time fluid volume in the bioreactor container 12. The rate of increase in fluid volume can be a constant value based on a theoretical, expected, or observed rate of growth of cellular components in the bioreactor container 12 and/or a rate of increase in volume required to achieve a desired phenotype of a cellular culture. In some embodiments, the fluid volume can be determined based on real-time calculations using optical sensor data, pressure sensor (e.g., load cell) data, and/or sparge rate or sparge volume.

In some embodiments, a controller 330 is advantageous or necessary to perform calculation (e.g., real-time calculation) of foam thickness 311 using non-constant values (and, optionally, one or more constant values) for foam distance, bioreactor container 12 weight, fluid volume, fluid density, and/or sparge rate. In some embodiments, a controller can be advantageous or necessary for operating an antifoam mechanism 390 or method based on a calculated foam thickness. In some embodiments, a system 10 described herein can be configured to include a controller for determination of foam thickness 311 and/or for operation of antifoam mechanisms 390 based on a measured or calculated foam thickness 311.

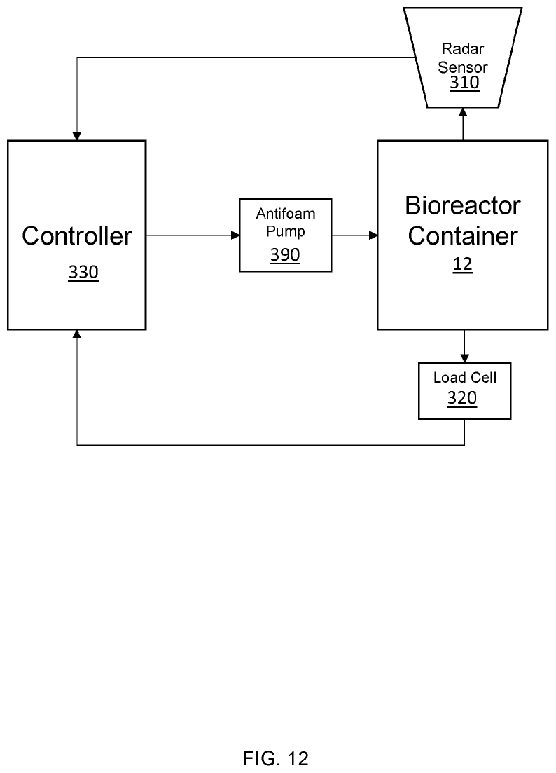

FIGS. 12-14 show configurations of fluid processing systems 10 that can allow for accurate monitoring and/or control (e.g., feedback-based control) of foam level thickness/height 311 in the systems. As shown in FIG. 12, a fluid processing system 10 can comprise a controller 330 configured to receive data from a distance measuring sensor 310 (e.g., radar sensor), such as to determine a foam thickness/height 311 of a bioreactor culture. In some embodiments, the controller can receive data from a mass measuring sensor 320 (e.g., load cell) in order to determine an amount of liquid 315 in the bioreactor container 12, which can be useful in determining a volume of the bioreactor container 12 occupied by the liquid portion of the cell culture. In some example embodiments, the controller 330 may be used to analyze data from the distance measuring sensor 310 and/or the mass measurement sensor 320. In some example embodiments, the controller 330 can operate an antifoam pump 390 or other antifoam-dispensing mechanism, such as when a foam level in the bioreactor container 12 is at or above a threshold setpoint value. In some embodiments, sensor data (e.g., from a radar sensor and/or a load cell sensor) can be provided directly to the controller 330, and the controller 330 can operate an antifoam mechanism (e.g., antifoam pump 390) directly based on the analysis of data provided to the controller 330 by one or more sensors (e.g., a distance measuring sensor 310 and/or a mass measurement sensor 320) of the system.

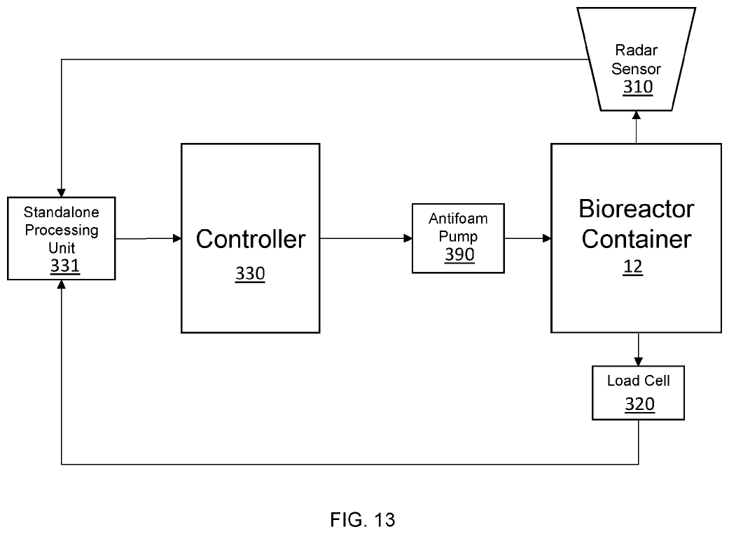

As shown in FIG. 13, a processor separate from the controller 330 (e.g., standalone processing unit 331) can be used to analyze data from one or more sensors of a fluid processing system 10 and to provide a calculated foam level value to the controller 330 (e.g., for use by the controller 330 to operate one or more foam management mechanisms). In some embodiments, use of the standalone processing unit 331 (e.g., to determine a foam level in the bioreactor container 12) can reduce the computational load on the controller 330, which can increase the speed of the fluid processing system 10 and its operation.

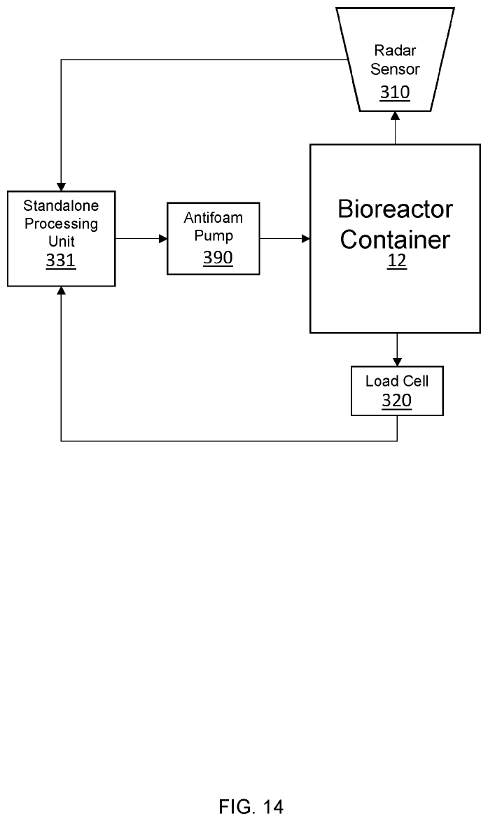

As shown in FIG. 14, an embodiment of the standalone processing unit 331 can be used to determine a foam level in the bioreactor container 12 (e.g., based on data provided to the processor by one or more sensors) and can provide the resultant value directly to an embodiment of the antifoam mechanism (e.g., the antifoam pump 390), such as without the need for a controller 330 to operate the antifoam mechanism. In some embodiments, obviating a need for the controller 330 by passing data from the processor (e.g., a standalone processing unit 331) directly to the antifoam mechanism can reduce the cost to operate and/or maintain the fluid processing system 10.

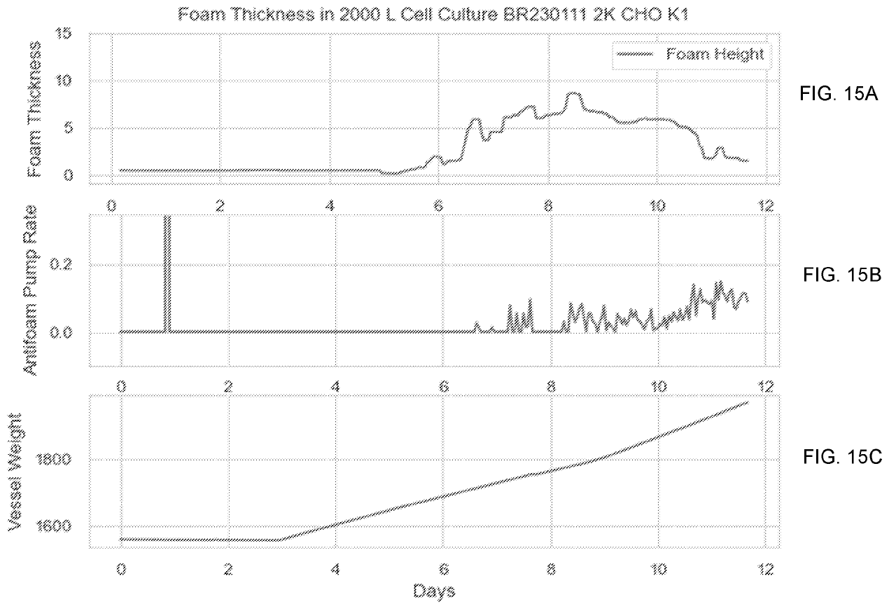

FIGS. 15A-15C show an example embodiment of a fluid processing system 10 used to determine foam level during culture (e.g., processing) of Chinese hamster ovary (CHO) cell line K1 (CHO K1) cells in 2,000 liter (L) a bioreactor container 12. As shown in FIG. 15C, the weight of the bioreactor increases from day 3 to day 12, indicating growth of the cell culture in the bioreactor container 12 and increase of the liquid volume in the bioreactor. FIG. 15A shows that foam level (e.g., foam thickness 311) can begin to increase at approximately day 6 of culture, peaking during day 8 of culture, and falling to baseline foam levels by day 12 of culture. FIG. 15B shows that antifoam pump rate can be increased at one or more points (for the same or different durations) during culture days 7-12. These data show that increases in foam level can be accurately determined by fluid processing systems 10 described herein.

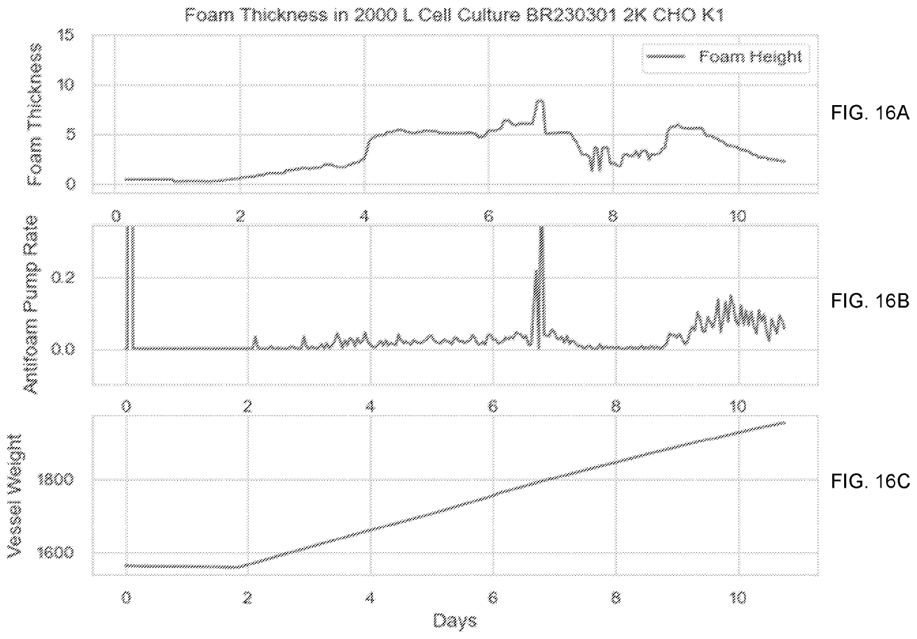

FIGS. 16A-16C show an example embodiment of a fluid processing system 10 used to determine foam level during culture (e.g., processing) of CHO K1 cells in a 2,000 liter (L) bioreactor container 12. As shown in FIG. 16C, the weight of the bioreactor increases from day 2 to day 11, indicating growth of the cell culture in the bioreactor container 12 and increase of the liquid volume in the bioreactor container 12. FIG. 16A shows that foam level (e.g., foam thickness 311) begins to increase slowly at approximately day 2 of culture, increasing rapidly during days 4 and 9 of culture, and decreasing following peak foam levels on days 7 and 9 of culture. FIG. 16B shows that antifoam pump rate is increased briefly during days 2 and 3 of culture, for a more prolonged duration from day 4 to day 6 during a plateau of foam thickness 311 shown in FIG. 16A, and peaking at day 7 and from day 9-11 when foam level rises beyond plateau levels. These data show that increases in foam level can be accurately determined and controlled by fluid processing systems 10 described herein.

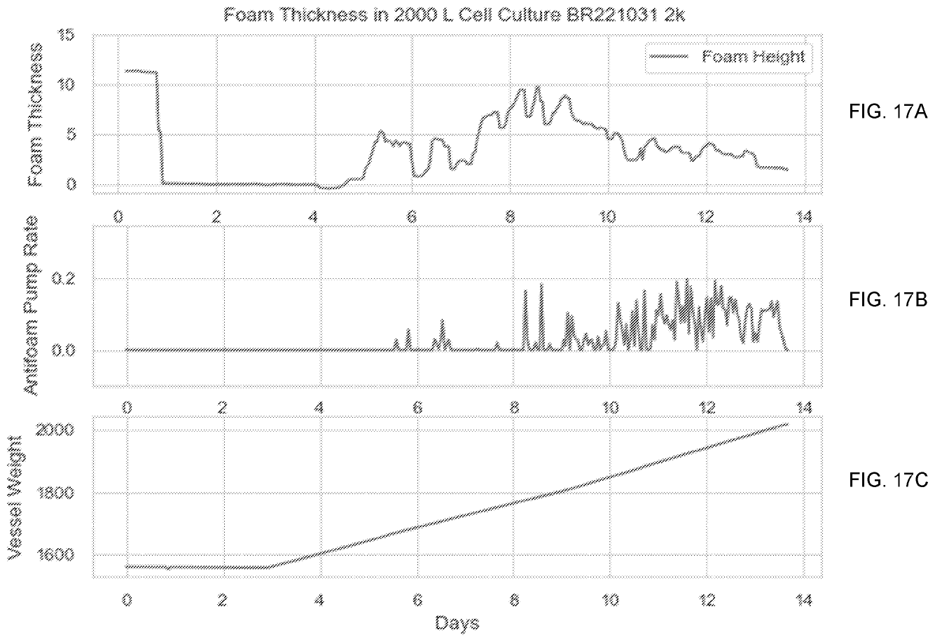

FIGS. 17A-17C show an example embodiment of a fluid processing system 10 used to determine foam level during culture (e.g., processing) of CHO K1 cells in a 2,000 liter (L) bioreactor container 12. As shown in FIG. 17C, the weight of the bioreactor container 12 increases from day 3 to day 14, indicating growth of the cell culture in the bioreactor container 12 and increase of the liquid volume in the bioreactor container 12. FIG. 17A shows that foam level (e.g., foam thickness 311) begins to increase at approximately day 5 of culture, peaking at days 8 and 9 of culture, and decreasing from day 9 to day 14 of culture. FIG. 17B shows that antifoam pump rate is increased briefly at approximately day 5 of culture. The antifoam pump 390 is operated from approximately day 8 and to approximately day 14 corresponding to the decrease in foam levels shown in FIG. 17A. These data show that increases in foam level can be accurately determined by fluid processing systems 10 described herein.

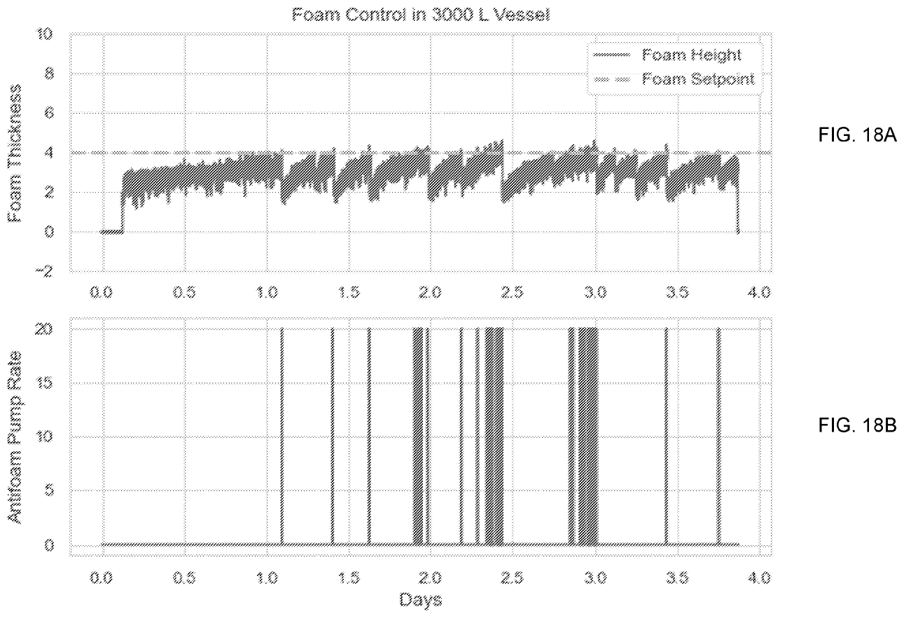

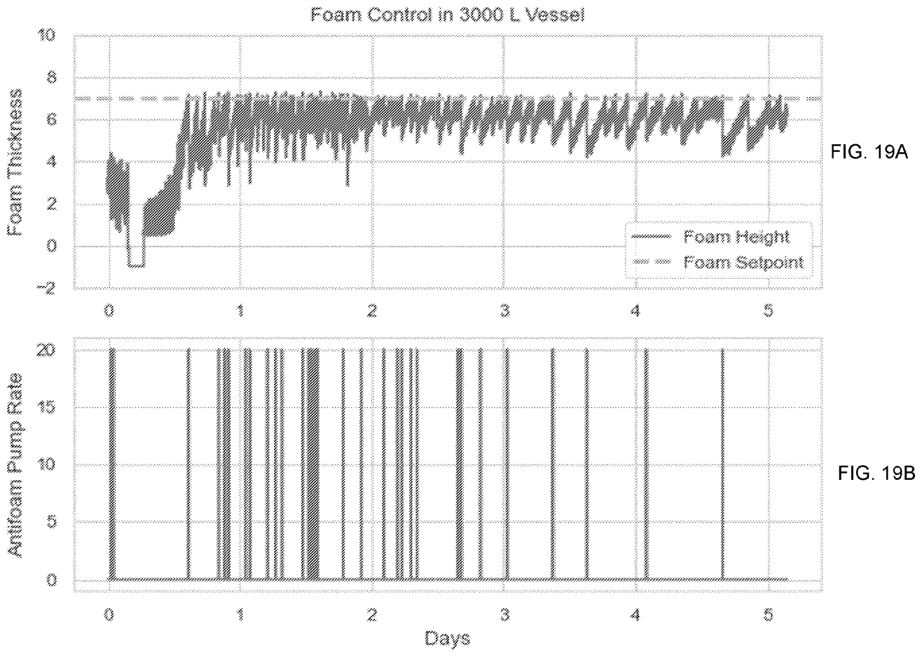

FIGS. 18A-19B show an example embodiment of a fluid processing system 10 used to control foam level during simulated culture conditions in a 3,000 liter (L) bioreactor container 12 based on a foam level setpoint threshold values (dotted line of FIGS. 18A and 19A). Cell culture foam conditions were simulated using a media simulant comprising a surfactant agitated in a fluid processing system using a constant air sparge rate. FIG. 18B shows that the antifoam pump 390 is operated when the calculated foam thickness 311 meets or exceeds the first foam level setpoint threshold value (FIG. 18A, dotted line). Foam height (FIG. 18A, solid line) decreases when the antifoam pump 390 is in operation (see, FIG. 18B). FIG. 19B shows that the antifoam pump 390 is operated when the calculated foam thickness meets or exceeds the second foam level setpoint threshold value (FIG. 19A, dotted line). Foam height (FIG. 19A, solid line) decreases when the antifoam pump 390 is in operation (see, FIG. 18B). These data show that increases in foam level can be accurately determined and controlled by fluid processing systems 10 described herein.

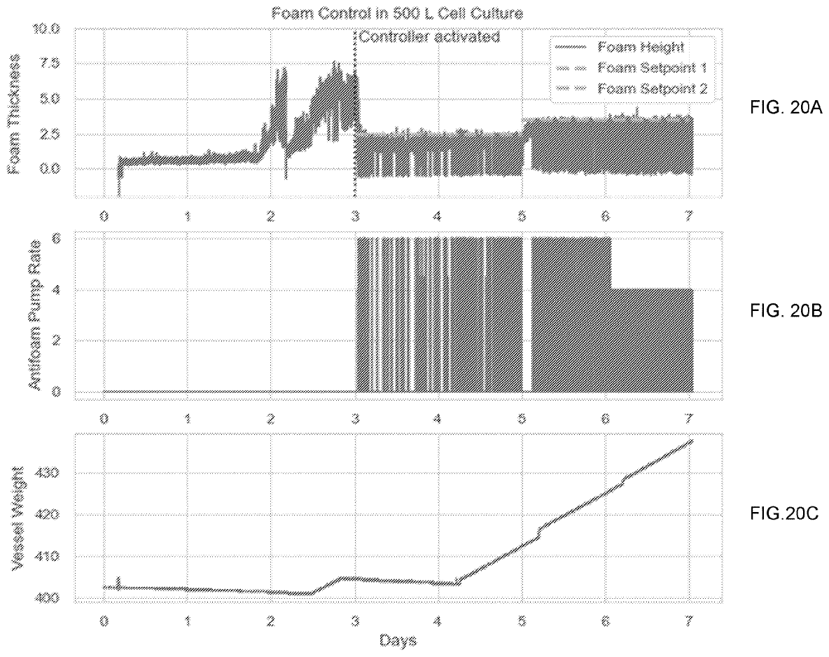

FIGS. 20A-20C show an example embodiment of a fluid processing system 10 used to control foam level during culture (e.g., processing) of CHO K1 cells in a 500 liter (L) bioreactor container 12 based on a first foam level setpoint threshold value and a second foam level setpoint threshold value (dotted lines of FIG. 20A). FIG. 20B shows that the antifoam pump 390 can be operated when the calculated foam thickness 311 meets or exceeds the first foam level setpoint threshold value (FIG. 20A, horizontal dotted line) on days 3 to 5 and when the calculated foam thickness 311 meets or exceeds the second foam level setpoint threshold value (FIG. 20A, horizontal dotted line) on days 5 to 7. Foam height is uncontrolled before the fluid processing system 10 is activated at day 3 of culture, with foam height increasing and decreasing rapidly before the fluid processing system is activated (FIG. 20A, vertical dotted line). Foam height (FIG. 20A, solid line) decreases when the antifoam pump 390 is activated (see, FIG. 20B). Foam height is well-controlled near the first foam level setpoint threshold value from days 3 to 5 and near the second foam level setpoint threshold value from days 5 to 7. FIG. 20B shows that the operation of the antifoam pump 390 is more frequent while maintaining the foam level at or below the second foam level setpoint threshold value. FIG. 20C shows that the liquid volume of the culture increases from approximately day 2 to day 3 and again from approximately day 4 to day 7. These data show that increases in foam level can be accurately determined and controlled by fluid processing systems 10 described herein at multiple foam thicknesses or heights. In some example embodiments, the effects shown by this data can be achieved using closed loop feedback control with the distance-measuring sensor 310 (e.g., radar foam sensor 310).

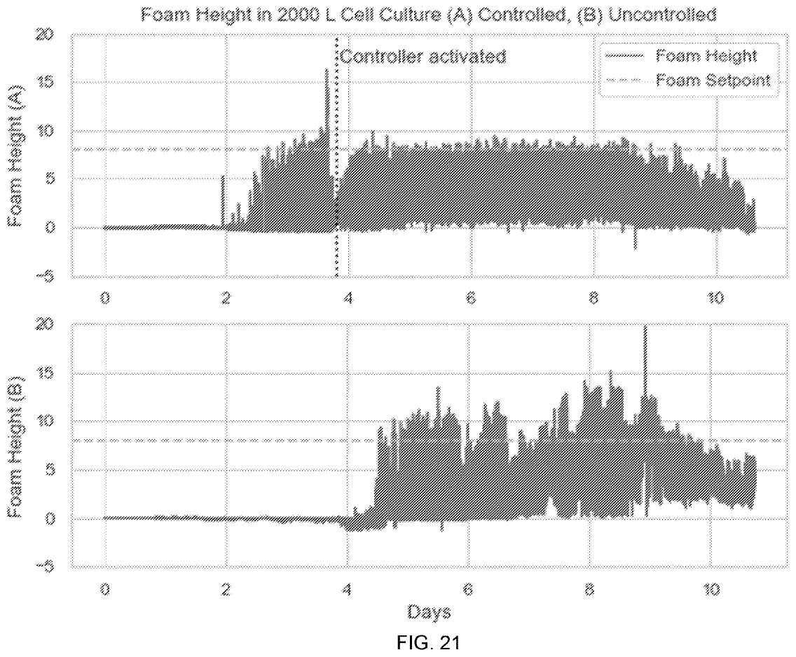

FIG. 21 shows an example embodiment of a fluid processing system 10 used to control foam level during culture (e.g., processing) of CHO K1 cells in a 2,000 liter (L) bioreactor container 12 based on a foam level setpoint threshold target value (horizontal dotted line of FIG. 21, upper panel), as compared to manual control of antifoam mechanisms without using a fluid processing system 10 (FIG. 21, lower panel). The upper panel of FIG. 21 shows foam level is uncontrolled prior to activation of the foam level measuring system of fluid processing system 10 at approximately day 4 of culture (vertical dotted line), at which point foam height is well-controlled by the fluid processing system 10 (e.g., via automatic operation of antifoam mechanisms based on the calculated foam level) from activation of the system to the end of the culture. In contrast, manual operation of antifoam mechanisms showed relatively poor control of foam level (FIG. 21, lower panel, solid line) relative to an identical foam level threshold target (horizontal dotted line). These data show that fluid processing systems 10 described herein provide better control of foam level in bioreactor culture systems.

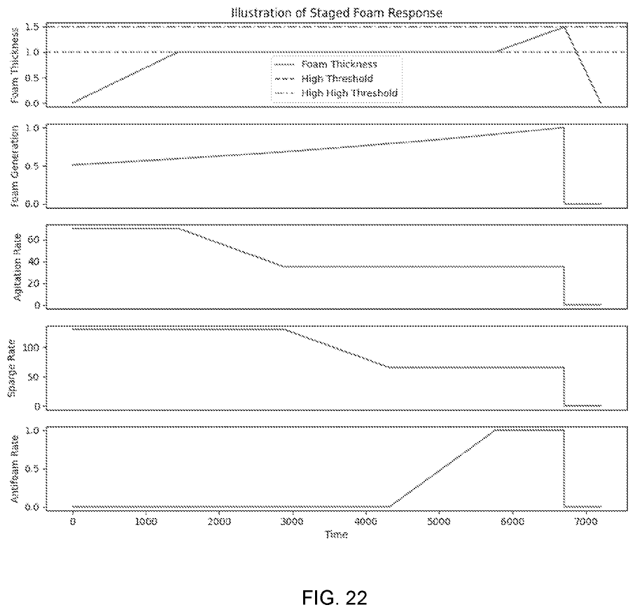

FIG. 22 shows some exemplary configurations of fluid processing systems 10 described herein. For example, a fluid processing system 10 can be configured to adjust (e.g., decrease) agitation rate or sparge rate and/or adjust (e.g., increase) antifoam mechanism operation in response to an increase in foam thickness 311 (e.g., as compared to a predetermined foam level setpoint threshold value). As shown in FIG. 22, multiple methods of controlling foam level (e.g., comprising one or more of decreasing agitation rate, decreasing sparge rate, and/or increasing frequency or intensity of antifoam mechanism operation) can be used simultaneously (e.g., as an antifoam program) or consecutively. In some embodiments, a fluid processing system 10 can be configured to proceed from a first antifoam program to a second antifoam program (and, optionally, one or more additional antifoam programs) For example, this can be performed if the first antifoam program (and/or subsequent antifoam programs) fails to satisfactorily control foam rate (e.g., by keeping foam level near or below a foam level threshold value). As shown in FIG. 22, a fluid processing system 10 can comprise an ultimate (e.g., “high high”) foam level threshold value, for example, to avoid catastrophic failure of the fluid processing system 10 (e.g., by shutting down all operation of bioreactor functions).

The many features and advantages of the disclosure are apparent from the detailed specification, and thus, it is intended by the appended claims to cover all such features and advantages of the disclosure which fall within the true spirit and scope of the disclosure. Further, since numerous modifications and variations will readily occur to those skilled in the art, it is not desired to limit the disclosure to the exact construction and operation illustrated and described, and accordingly, all suitable modifications and equivalents can be resorted to, falling within the scope of the disclosure.

1. A system for determining a measurement of a foam layer in a fluid processing system, the system comprising:
a container having a chamber for containing a liquid and the foam layer, the foam layer present above the liquid;
a first sensor positioned adjacent a top portion of the container, the first sensor configured to measure a foam distance between a top foam surface of the foam layer and the first sensor;
a second sensor positioned adjacent to the container, the second sensor configured to receive a measurement to determine a top liquid surface height of the liquid; and
a controller communicatively coupled to the first sensor and the second sensor, the controller configured to perform operations comprising:
calculating a thickness of the foam layer based on a difference between the measured foam
distance and the measurement received from the second sensor.

2. The system of claim 1, wherein the operations further comprise:
determining whether the calculated thickness of the foam layer satisfies a foam layer threshold, the foam layer threshold defining when the foam layer is to be reduced; and
performing, in response to satisfying the foam layer threshold, an action to reduce the foam layer.

3. The system of claim 2, wherein the action comprises adding a volume of an anti-foam solution to the chamber.

4. The system of claim 2, wherein the action comprises activating or adjusting a component of the fluid processing system.

5. The system of claim 3, wherein the volume of the anti-foam solution added to the chamber is based on at least one of a proportional-integral-derivative (PID) control algorithm or a model predictive control algorithm.

6. The system of claim 3, wherein the volume of the anti-foam solution added to the chamber is determined based on the calculated thickness or a calculated volume of the foam layer.

7. The system of claim 1, wherein the first sensor and the second sensor are the same sensor.

8. The system of claim 1, wherein the first sensor and the second sensor are radar sensors.

9. The system of claim 1, wherein the determining the calculated thickness of the foam layer further comprises performing the operations of:
obtaining, from the first sensor, a reference distance between a base of the chamber and the first sensor;
obtaining, from the first sensor, the foam distance between the top foam surface of the foam layer and the first sensor; and
calculating a first distance based on a difference between the foam distance and the reference distance.

10. The system of claim 9, wherein the determining the calculated thickness of the foam layer further comprises performing the operations of:
determining the top liquid surface height of the liquid; and
calculating the thickness of the foam layer by determining a difference between the first distance and the top liquid surface height of the liquid.

11. The system of claim 10, wherein the determining the top liquid surface height of the liquid comprises calculating a volume of the liquid.

12. The system of claim 11, wherein the volume of the liquid is calculated using a measured mass of the liquid taken by the second sensor and a density of the liquid.

13. The system of claim 9, wherein the top liquid surface height of the liquid is determined using a measured pressure of the liquid taken by the second sensor.

14. The system of claim 11, wherein a gas holdup volume in the volume of the liquid is determined for determining the thickness of the foam layer.

15. The system of claim 11, wherein the volume of the liquid is calculated using at least one dimension of the chamber.

16.-24. (canceled)

25. A method for determining a measurement of a foam layer in a container of a fluid processing system, the method comprising:
measuring, with a first sensor, a distance between the first sensor and a top surface of the foam layer on top of a liquid in the container;
measuring, with a second sensor, a mass of the liquid or a pressure exerted by a column height of the liquid in the container; and
calculating, using one or more processors, a thickness of the foam layer based on the distance between the first sensor and the top surface of the foam layer and at least one of the mass of the liquid and the pressure exerted by a column height of the liquid.

26. The method of claim 25, further comprising:
determining, using the one or more processors, whether the calculated thickness of the foam layer satisfies a first foam layer threshold, the first foam layer threshold defining when the foam layer is to be reduced; and
controlling an action, using a controller, to reduce a presence and/or formation of the foam layer in response to satisfying the first foam layer threshold.

27. The method of claim 26, further comprising:
determining, using the one or more processors, whether the calculated thickness of the foam layer satisfies a second foam layer threshold, the second foam layer threshold defining when the foam layer is to be reduced; and
controlling the action, using the controller, to reduce a presence and/or formation of the foam layer in response to satisfying the second foam layer threshold.

28. The method of claim 26 or claim 27, wherein the action comprises adding a volume of an anti-foam solution to the container.

29. The method of claim 26 or claim 27, wherein the action comprises activating or adjusting one or more components of the fluid processing system.

30.-61. (canceled)
